(19) United States
(12) Patent Application Publication
(10) Pub. No.: US 2003/0134591 A1
(43) Pub. Date: Jul. 17, 2003

(54) Digital remote signaling system

(76) Inventors: Mark Gary Roberts JR., Gig Harbor, WA (US); Thomas Lee Jacobson, Sedro Woolley, WA (US); Neal Howard Rothenbuhler, Acme, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/053,232

(22) Filed: Jan. 17, 2002

(51) Int. Cl. H04Q 7/20; H04H 7/00

(52) U.S. Cl. 455/3.06; 455/426

(57) ABSTRACT

A system is provided for communicating encoded signals to control a device for performing work related to yarding operations. The system includes a transmitter for transmitting an encoded signal having two or more digital portions. The first portion is a preamble, and a second portion is an action code. The system also includes a receiver for receiving the encoded signal to produce a controlling signal. The receiver is activated to process the action code to produce the controlling signal, thereby controlling the device for performing work related to yarding operations, when the preamble is of a predetermined pattern.

### FIELD OF THE INVENTION

This invention generally relates to the field of communication systems, and more particularly, to an enhanced signal that carries encoded data to control a yarding process or voice information related to yarding operations in logging operations.

### BACKGROUND OF THE INVENTION

Logging operations, such as those in the Pacific Northwest area of the United States, typically use aerial or high-lead cable logging systems utilizing skyline carriages (also known as motorized carriage). One such system is shown in FIG. 1, where a motorized carriage 30 traverses a skyline 10 to move downed logs from a remote location to a logging yard. The skyline 10 is anchored at its uphill and downhill ends to stumps. The skyline 10's wire-strand rope is supported between its anchored ends by spars 12 and 14. The skyline 10 is sufficiently taut to hold it above the ground at all points. The skyline 10 extends over sheaves 16 and 18 at the upper ends of each of the spars 12 and 14, and from there descends to the ground, where it is anchored to a stump or other suitable anchor.

The motorized carriage 3 0 is controlled in its travel along the skyline 10 by a main line cable 20, extending from the motorized carriage 30 over the groove of a pulley 22 and wound around a cable-winding drum 24 of a yarder 26. The yarder 26, through the cable-winding drum 24, pulls the motorized carriage 30 to the uphill end of the skyline 10 and also controls the downhill travel of the motorized carriage 30 so that it can transport logs 50, 51 held by a choker 48.

Workers of logging operations, such as worker 54, are widely dispersed between the logging yard, where yarder 24 may be located, and the outlying areas where the trees may be found. When a sufficient number of logs 50, 51 are tethered to the motorized carriage 30 via the choker 48, the yarder 24 may be set to reel in the motorized carriage 30 so that the logs 50, 51 can be transported back to the landing where logs are kept. Changes in the operation of yarding machinery may be difficult to coordinate and communicate. Consequently, workers who are caught unaware of changes in the operation of the yarding machinery may get hurt when the motorized carriage 30 speedily drags logs 50, 51 along a path on which these workers may be situated.

As a result, encoded audio signals (“whistle signals” in the idiom of the logging industry) have been invented as a means of communication among workers in the field. Each signal may represent a specific instruction from one worker to another and usually pertains to the operation of a specific type of logging machinery. In addition to its use for communicating instructions from one worker to another, whistle signals serve a safety function in alerting other workers in the vicinity of changes in the operation of the machinery. In recognition of the safety aspect of the use of whistle signals, various states and regulatory agencies have promulgated laws and regulations mandating the use of standardized whistle signals in logging operations.

Presently, the worker 54 is outfitted with a whistle controller 56 and often a motorized carriage controller 58. When the worker 54, as part of a choker setter crew, has tethered sufficient logs 50, 51 to the motorized carriage 30 via the choker 48, he uses the whistle controller 56 to remotely send encoded audio signals back to the yarder 26 where a receiver 60 receives and processes the audio encoded signals so that these audio encoded signals can be reproduced by an air horn 62. The sounds projected by the air horn 62 reverberate throughout the logging area allowing workers in the field to be forewarned of changes in the operation of the yarding machinery. As an added safety measure, a loudspeaker (not shown) may be mounted in the cab of the yarder 26. Voice commands may be issued from the whistle controller 56 to the loudspeaker so as to alert the operator of the yarder 26 regarding imminent dangers to the worker 54. As another safety measure, the worker 54, by using the motorized carriage controller 58, may control the operations of the motorized carriage 30, such as stopping, starting, dropping the choker 48 down, pulling the choker 48 up, and accelerating at various speeds.

These controllers 56, 58 have worked very well. The logging industry has come to rely on these controllers 56, 58 over the years to better coordinate yarding operations as well as to prevent serious injuries to workers. However, there has been a long-felt need to further enhance these controllers 56, 58 in various areas, such as operations, service, manufacturing, and user interface, so that these controllers 56, 58 may continue to improve the difficult and dangerous working environment for logging workers.

Regarding the operation of controllers 56, 58, presently, the whistle controller 56 sends one or more analog tones of a specified frequency and duration so as to trigger the receiver 60, thereby enabling the air horn 62 to output desired whistle signals. Other signals that do not comport to this encoding format should not be able to activate the receiver 60. However, ambient signals that may have once been limited to urban sources, such as personal communications devices or portable 2-way radios, may now encroach upon remote locations of yarding operations, and thereby potentially interfere with the proper reproduction of whistle signals.

These analog tones that trigger the receiver 60 may occupy a large portion of the bandwidth or time portion of the communication channel used for communicating the audio encoded signals. Thus, a controller of one worker or interfering party may undesirably dominate the communication channel to the detriment of other workers who may need to use it. For example, while the worker 54 is negotiating with the underbrush in the forest, a branch may inadvertently wedge against a button to indefinitely activate the whistle controller 56. This freezes out or blocks other workers from being able to use the communication channel to transmit an alert signal for impending logging operations. Thus, a need exists for compressed information format and less-occupied channels.

Given that the worker 54 may have to walk through thickets of trees and wild vegetation, these controllers 56, 58 may get tangled, dropped to the ground, and become lost. When one of these controllers 56, 58 are lost by workers, it could become rather costly to replace it, so there is a need for a way to find and retrieve lost controllers. Moreover, yarding operations may be complex, and when an accident or malfunction happens, it may be difficult to understand how it occurred, making it difficult to improve the safety of workers in the future. Thus, there is a need to help analyze and understand a sequence of events that may have lead to an accident or malfunction.

Controllers 56, 58 originated separately from one another. Additionally, each controller has evolved over years of manufacture. Each has developed parts different from the other. Given the numerous parts used by the controllers 56, 58, their manufacture has been labor intensive, making them costly to produce. Also, some workers have found it cumbersome to carry two separate controllers 56, 58 while performing logging operations. A need exists, therefore, for consolidating, minimizing, and simplifying equipment.

Although both controllers 56, 58 are designed to withstand the rugged use, it would be desirable to decrease the need for servicing to replace parts that are susceptible to breakage due to shock. When controllers 56, 58 do have to be serviced, their housings have to be laboriously opened up. Even to calibrate parts, such as the frequency of a crystal oscillator, has been very labor intensive.

Regarding the user interface of controllers 56, 58, presently, the way the worker 54 knows that his actuation of controllers 56, 58 has been successful is by either listening for the projected whistle signals from the air horn 62, or by watching the operation of the motorized carriage 30. Because of the lack of immediate feedback and distance the sound travels, the worker 54 has to wait for a period of time until he can obtain either an aural or visual confirmation that the command he placed with controllers 56, 58 has been carried out. On some occasions out in the field, the worker 54 may begin to operate one of the controllers 56, 58 only to discover that the battery of one or both of them has been completely depleted. Thus, it would be an enhancement for controller 56, 58 to inform the worker 54 that the charge of the battery may be near depletion.

Thus, although controllers 56, 58 continue to perform the functions for which they were designed, it would be desirable to address the long-felt need to enhance these controllers so that the difficult and dangerous working environment of logging workers may be further improved.

### SUMMARY OF THE INVENTION

One aspect of the present invention includes an encoded signal that comprises multiple digital portions. The first digital portion is defined as a preamble. If the preamble contains a bit pattern not expected by the receiver, the entire encoded signal may be discarded. The encoded signal also includes another portion defined as a network identifier. The network identifier contains a source node identifier and a destination node identifier. The receiver is programmed to recognize a predetermined destination node identifier and a set of source node identifiers. Typically, the predetermined destination node identifier uniquely identifies the receiver, and the set of source node identifiers are the identities of the transmitters that are authorized to communicate with the receiver. The receiver may discard the encoded signal when either the source node identifier contained in the network identifier is not a member of the set of source node identifiers, or the destination node identifier contained in the network identifier is different from the predetermined destination node identifier as recognized by the receiver. In this way, the method may inhibit unauthorized signals from interfering with the communication between a transmitter and a receiver to control the device for performing work related to yarding operations.

Another aspect of the present invention includes a method for inhibiting a transmitter from dominating a communication channel for an indefinite period of time. This may be accomplished by forming encoded signals as digital signals having a short duration of transmission, or by limiting the voice signals to a predetermined duration (so that the worker may need to reestablish voice communication). Another aspect of the present invention may include a transceiver that can communicate with a “lost” transmitter so as to locate it for retrieval. The transceiver may command the lost transmitter to issue a lost encoded signal containing various pieces of digital information, such as a network identifier, to help the transceiver locate the lost transmitter. To better understand a course of events that led to an incident during yarding operations, another aspect of the present invention provides a recorder that may record each encoded signal when the transmitter issues it to the receiver. To understand which transmitter and receiver were involved leading to the incident, the recorder may record the source node identifier of the issuing transmitter and the destination node identifier of the involved receiver.

Another aspect of the present invention includes the use of common parts in the manufacturing of the transmitters and the receivers (although not all parts need be common). The use of common parts enables a single transmitter to be manufactured to both control a air horn as well as to control a piece of yarding machinery, such as a motorized carriage. Another aspect of the present invention includes providing an interface with the transmitter. Whenever the transmitter needs to be reconfigured or recalibrated, programming signals can be provided to the interface to effect the desired changes. The same interface may also be manufactured to receive power signals to charge a battery inside the transmitter.

A further aspect of the present invention includes providing a local feedback, such as an aural indicator, on the transmitter to audibly indicate to the user that the transmitter has received the commands from the user, such as an actuation of a switch, or that an operation state of the transmitter may undergo a change, such as the near depletion of the charge of the battery of the transmitter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating the communication of analog audio encoded signals relating to yarding operations according to the prior art.

FIG. 2 is a block diagram illustrating a system for communicating digital signals between a transmitter and a receiver and between a transmitter and a transceiver according to one embodiment of the invention.

FIGS. 3A-3C are block diagrams illustrating digital data signals and voice signals communicated between a transmitter and a receiver and between a transmitter and a transceiver according to one embodiment of the invention.

FIG. 4 is a block diagram illustrating a system for communicating between a transmitter and a receiver and between a transmitter and a transceiver, the transmitter being shown with various subsystems and subcomponents according to one embodiment of the invention.

FIG. 5A is a block diagram illustrating a communication relationship between a switch on a transmitter and a translator on the transmitter to produce an action code according to one embodiment of the invention.

FIG. 5B is a table illustrating a mapping between an analog sequence of switch presses and releases to a set of binary strings, and a mapping of the set of binary strings to a set of action codes according to one embodiment of the invention.

FIG. 6A is a process diagram illustrating a top level software flow to wake up a transmitter to perform a scheduled task according to one embodiment of the invention.

FIG. 6B is a process diagram illustrating a software flow to program a transmitter according to one embodiment of the invention.

FIG. 6C is a process diagram illustrating a software flow to check a battery level of a transmitter according to one embodiment of the invention.

FIG. 6D is a process diagram illustrating a software flow to detect an actuation of a switch and to transmit a signal in accordance with the actuation of the switch according to one embodiment of the invention.

FIG. 6E is a process diagram illustrating a software flow to determine the orientation of a transmitter according to one embodiment of the invention.

FIG. 6F is a process diagram illustrating a software flow from FIG. 6E to transmit a selected alert signal so that a transmitter can be found according to one embodiment of the invention.

FIG. 6G is a process diagram illustrating a software flow from FIG. 6D to translate an actuation of a switch or a sequence of actuations to form an action code according to one embodiment of the invention.

FIG. 7A is a process diagram illustrating a software flow of a receiver according to one embodiment of the invention.

FIG. 7B is a process diagram illustrating a software flow of the receiver from FIG. 7A according to one embodiment of the invention.

FIG. 8 is a process diagram illustrating a software flow of a transceiver receiving a “lost” encoded signal from a transmitter according to one embodiment of the invention.

FIG. 9A is a circuit block diagram illustrating a radio frequency circuit of a transmitter according to one embodiment of the invention.

FIG. 9B is a circuit block diagram illustrating a controller circuit for a transmitter according to one embodiment of the invention.

FIG. 9C is a circuit block diagram illustrating a combining circuit for a transmitter according to one embodiment of the invention.

FIG. 9D is a circuit block diagram illustrating a circuit for providing power to various circuits of a transmitter according to one embodiment of the invention.

FIG. 10A is a circuit block diagram illustrating a radio frequency circuit of a receiver according to one embodiment of the invention.

FIG. 10B is a circuit block diagram illustrating a controller circuit as well as a portion of a relay circuit for a receiver according to one embodiment of the invention.

FIG. 10C is a circuit block diagram illustrating an audio amplifier for a receiver according to one embodiment of the invention.

FIG. 10D is a circuit block diagram illustrating two regulator circuits for providing power to the controller circuit as well as the radio frequency circuit of the receiver according to one embodiment of the invention.

FIG. 11A is an isometric view of a transmitter according to one embodiment of the present invention.

FIG. 11B is an isometric view showing a bottom of a transmitter illustrating an interface for programming the transmitter and for recharging the battery of the transmitter according to one embodiment of the present invention.

FIG. 11C is a block diagram of the coupling relationships between the interface as shown in FIG. 11B and the various circuits of the transmitter according to one embodiment of the present invention.

FIG. 12 is plan diagram of a transmitter illustrating various orientations of a transmitter for changing the operations of the transmitter according to one embodiment of the present invention.

FIGS. 13A-B are plan diagrams of a transmitter illustrating various programmable storage positions according to one embodiment of the present invention.

### DETAILED DESCRIPTION OF THE PREFERRED EMBODIMENT

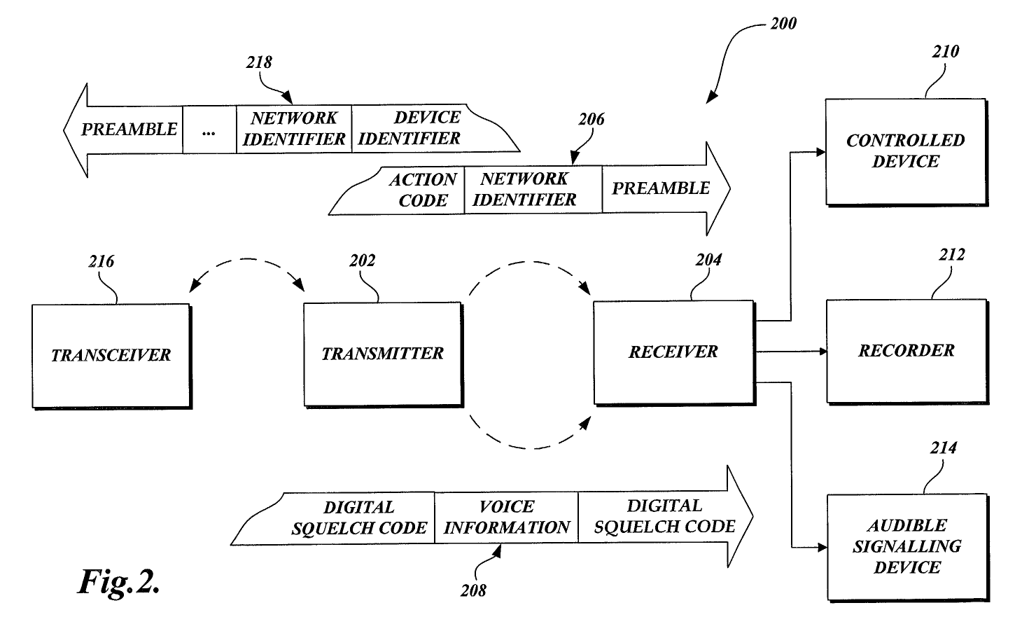

As the frequency spectrum gets more and more crowded over the years, even remote locations where logging operations take place experience interference from signal sources that were thought to exist only in an urban environment. As a result, radio frequency systems used in logging operations may have to be enhanced to deal with such interference. FIG. 2 illustrates one embodiment of a system 200 that focuses on the above problem. The system 200 includes a transmitter 202 communicatively coupled to a receiver 204. The transmitter 202 may be a hand-held device that can be used by a worker to send information to a receiver 204 to control a device 210 for performing work related to yarding operations and/or to control an audible signaling device 214 so that an audible safety signal may be sounded to forewarn workers of impending changes in the operation of yarding machinery. The device 210 can be any yarding machinery, such as a yarder or a motorized carriage.

The information that is transmitted by the transmitter 202 includes an encoded signal 206 that comprises multiple digital portions. Because of the digital nature of the encoded signal 206, the information may be quickly transmitted and received so as to occupy little bandwidth of the communication channel, thereby allowing other transmitters (not shown) to send information to the receiver 204. The encoded signal 206, as described in detail below, contains a digital portion called a network identifier, which forms a secure mechanism to prevent interference or unauthorized sources from controlling the device 210. The encoded signal 206 includes information that indicate the movement of the motorized carriage traversing the skyline.

The information transmitted by the transmitter 202 may include a voice signal 208, which can be received by the receiver 204 and output to the audible signaling device 214. The voice signal 208 includes a digital squelch code that heralds the beginning and another digital squelch code that signals the end of analog voice information being sent along the voice signal 208. Unless the digital squelch code of the audio signal 208 matches an expected pattern at the receiver 204, the receiver 204 will ignore the entire voice signal 208.

The receiver 204 is also coupled to a recorder 212. Whenever the receiver 204 receives a valid encoded signal, the recorder 212 records the encoded signal 206 in a history file. The contents of the history file of the recorder 212 may be sorted by the network identifier. One use for the history file of the recorder 212 may be to analyze an incident relating to yarding operations.

Typically, workers carry the transmitter 202 with them out into the field where logging operations may take place. Given the tangled and obstructing underbrush of the forest, the transmitter 202 may inadvertently become untethered from its owner and dropped to the ground. It may be some time before the owner of the transmitter 202 discovers that the transmitter 202 is lost somewhere in the forest. To recover the transmitter 202, a transceiver 216 may be used to help locate the transmitter 202 so that the transmitter 202 can be retrieved. There are several ways that the transceiver 216 may locate the transmitter 202. One way is for the transceiver 216 to wirelessly communicate with the transmitter 202 so that the transmitter 202 issues a “lost” encoded signal 218 to the transceiver 216. Using the “lost” encoded signal 218 may help the transceiver 216 to locate the transmitter 202.

The “lost” encoded signal 218 contains multiple digital portions. Among them is a device identifier portion that uniquely identifies the transmitter 202. The device identifier may include a serial number, which is stored in the transmitter 202 at manufacturing.

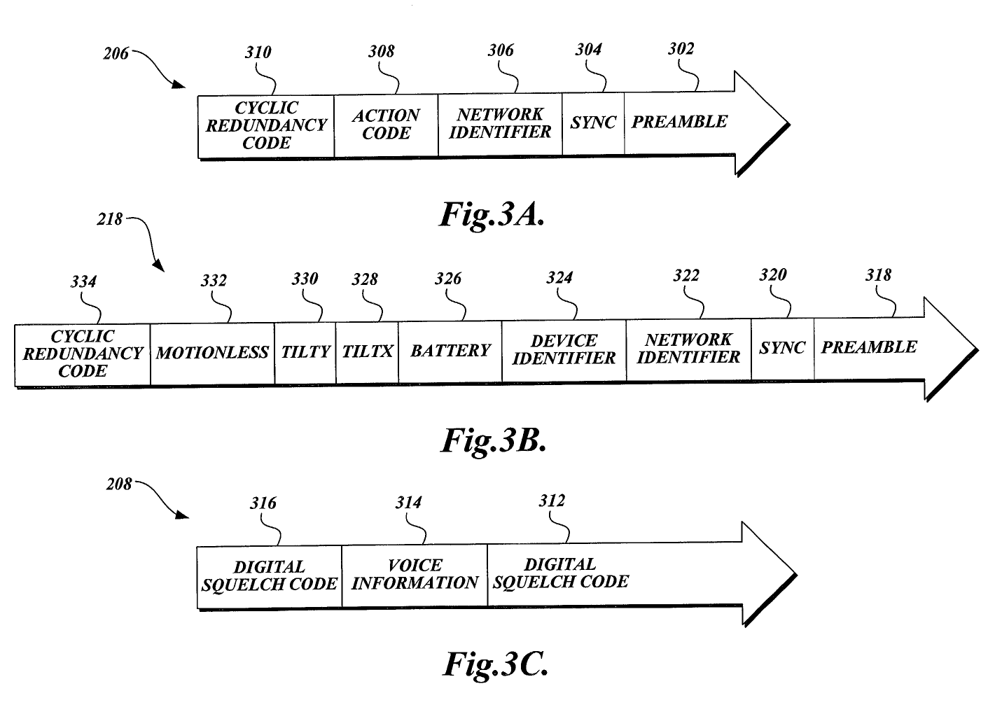

The encoded signal 206 discussed in FIG. 2 is shown in more detail in FIG. 3A. The multiple digital portions of the encoded signal 206 include a preamble 302. The preamble 302 includes a bit pattern that may be recognized by the receiver 204 to herald the beginning of a potentially valid encoded signal. One example of a preamble includes multiple repeated 8-bit words. Such a repeating pattern may ease the ability of the receiver 204 to recover the data clock associated with the encoded signal 206, and in addition, such a repeating pattern allows the demodulator used in the receiver 204 to be economically chosen, such as a Gaussian Minimum Shift Keying (GMSK) demodulator. The bit pattern of the preamble 302 can be chosen from any pattern, such as CCh, in hexadecimal, or 11001100b, in binary.

Another digital portion is a sync 304. The sync 304 allows a delineation of the end of the preamble 302 and the rest of the encoded signal 206. Any suitable bit pattern for the sync 304 may be used, such as 74h, in hexadecimal, or 01110100b, in binary.

A digital portion defined as a network identifier 306 follows the sync 304. The network identifier 306 generally contains a source node identifier, indicating the identity of the transmitter that transmits the encoded signal 206, and a destination node identifier, indicating the identity of the receiver to receive the encoded signal 206. Each identifier is configurable, thereby allowing multiple systems 200 to operate near each other without acting on each other's encoded signals. These identifiers also inhibit interfering signals. For example, a receiver can be configured to accept encoded signals from a predetermined set of transmitters having corresponding source node identifiers. If a transmitter has a source node identifier that is not a member of the set recognized by the receiver, the encoded signal will be discarded. Moreover, each transmitter is configured to communicate to a particular receiver. If the receiver receives an encoded signal having a destination node identifier that does not match that of the receiver, the encoded signal will be discarded as well.

Following the network identifier 306 is an action code 308. The action code 308 is generated by the transmitter 202 as indicated by a sequence of switch presses and releases on the transmitter 202. Each action code 308 may communicate a change in an operation of a piece of yarding machinery, such as stopping or starting a motorized carriage. A cyclic redundancy code 310 is also provided as part of the encoded signal 206. Cyclic redundancy code 310 allows the receiver 204 to check for errors in the received encoded signal. If there are too many errors in the encoded signal, the receiver 204 may opt to discard the received encoded signal altogether. Optionally, the digital portions 204, 306, 308, and 310 may be scrambled by a scrambler so as to more uniformly distribute ones and zeros in the transmitted bit stream, thereby easing the burden of a demodulator on the receiver 204.

FIG. 3B illustrates a “lost” encoded signal containing multiple digital portions that are sent from the transmitter 202 to the transceiver 216. A number of the digital portions of the “lost” encoded signal 218 are similar to a number of digital portions of the encoded signal 206, and for the sake of brevity, they will not be further discussed, namely preamble 318, sync 320, network identifier 322, and cyclic redundancy code 324. One of the digital portions of the “lost” encoded signal 218 includes a device identifier portion 324. The device identifier uniquely identifies the transmitter 202. Another digital portion of the “lost” encoded signal 218 includes information relating to the current battery level of a battery of the transmitter 202. This portion is defined as battery 326.

Information relating to the orientation of the transmitter 202 is sent in two portions, tilt x 328 and tilt y 330. These two portions may be used by the transceiver 216 to derive spatial information in regard to how the transmitter 202 is lying on the ground. Another portion of the lost encoded signal 218 is a portion defined as motionless 332. This portion indicates how long the transmitter 202 has been motionless. Optionally, various portions may be scrambled, such as portions 320, 322, 324, 326, 328, 330, 332, and 334, so that the zero bits and the one bits of the data stream may be more evenly distributed, thereby enhancing the demodulation of the “lost” encoded signal 218 by the transceiver 216.

FIG. 3C illustrates a voice signal 208 that can be transmitted from the transmitter 202 to the receiver 204. The voice signal 208 begins with a digital squelch code 312. This digital squelch code, if recognized by the receiver 204, enables the audible signaling device 214. Once enabled, the audible signaling device 214 may subsequently broadcast the voice information 314 portion of the voice signal 208, which is analog. To indicate that the voice signal 208 is over, the transmitter 202 provides a second digital squelch code 316 to indicate the end of the transmission of the voice signal 208.

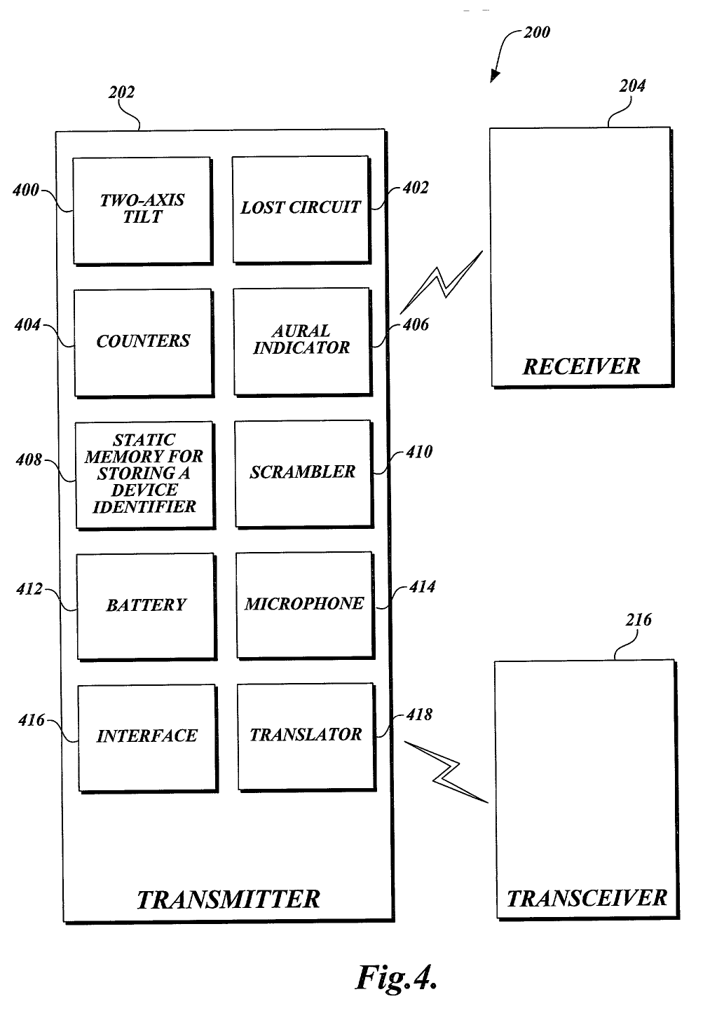

Several components of the transmitter 202 are illustrated in FIG. 4. The transmitter 202 includes a solid-state single-axis tilt sensor 400 to monitor the orientation of the transmitter 202 although in one embodiment a two-axis tilt sensor may be used. In one embodiment of the invention, the orientation of the transmitter 202 determines the type of signals such as an encoded signal or a voice signal, that will be transmitted. Various states of the software process of the transmitter 202 may also depend on the orientation of the transmitter 202 as well as whether the transmitter 202 is in motion. By using the two-axis tilt sensor 400, if there is a change in the orientation of the transmitter 202 within a predetermined duration, the transmitter 202 may be considered to be in motion.

A “lost” circuit 402 is also included in the transmitter 202. Using a variety of factors, such as the orientation and motion, the transmitter 202 may be considered “lost” by the software process. In such a case, either the transmitter 202 or the transceiver 216 may command the “lost” circuit 402 to transmit a “lost” encoded signal 218 so that the transceiver 216 may locate and retrieve the transmitter 202.

A number of counters 404 are included in the transmitter 202, such as a counter for counting the duration of time that the transmitter 202 has remained motionless. That information may be transmitted along with other digital portions carried by the “lost” encoded signal 218 to the transceiver 216.

The user interface of the transmitter 202 is enhanced with the aural indicator 406. The aural indicator 406 can be used to communicate to a user that a switch press has taken place, a state of the software has changed, the battery level is low, an error condition is detected, an audible alert is projected to help find the transmitter, or any other types of sound that help a user to better understand the operation of the transmitter 202.

The transmitter 202 includes several pieces of static memory, such as a piece of static memory for storing a device identifier 408 as well as calibration values, network identifiers, and operational constants. As previously discussed, the device identifier may include a serial number to uniquely identify the transmitter 202. A scrambler 410 is among the components of the transmitter 202. The scrambler 410 scrambles a portion of the encoded signal 206 or the “lost” encoded signal 218 so that “1” bits and “0” bits are more uniform in the transmitted data stream.

The transmitter 202 includes a battery 412 for providing a source of operating power. A microphone 414 allows voice communication to be transmitted from the transmitter 202. In one embodiment, the transceiver 216 may command the microphone 414 to be turned on so that the transmitter 202 may be located by the sound that is picked up by the microphone 414.

An interface 416 allows the battery 412 to be recharged and at the same time allows the software or various parameters of the transmitter 202 to be configured or updated. The interface 416 allows the transmitter 202 to be configured without having to open up the housing of the transmitter 202.

A translator 418 on the transmitter 202 translates a sequence of switch presses and releases to form an action code that is included in the encoded signal 206. The translator 418 captures a complete sequence to form the action code 308. This allows the transmitter 202 to form a complete package of information, such as the encoded signal 206 or the “lost” encoded signal 218, before using a channel in the spectrum to transmit information to either the receiver 204 or the transceiver 216. This helps to keep the channel open for other workers to communicate to the receiver 204, and prevents any one transmitter from dominating the channel to communicate with the receiver 204.

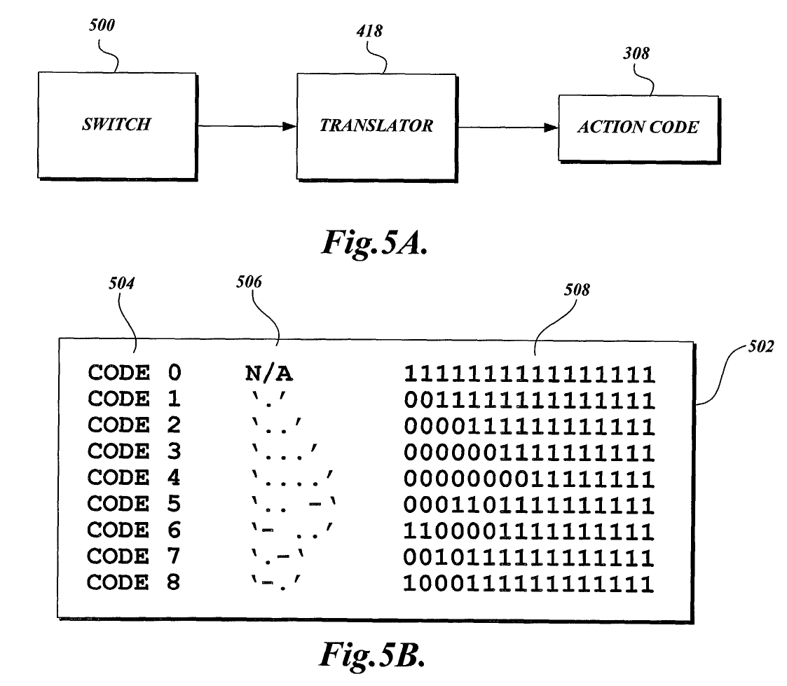

When a switch 500 is actuated, as shown in FIG. 5A, the translator 418 collects each press and each release of the switch 500 to form a sequence. This sequence is indicative of a desire of the user of the transmitter 202 to change an operation of a piece of yarding machinery. To detect the end of a sequence, the translator 418 waits for a release of a long duration, such as 500 ms to 620 ms or greater. The translator 418 also determines whether each press is a short press or a long press. Similarly, the translator 418 also determines whether a release is a short release or a long release. One exemplary technique of distinguishing between a long and a short includes defining a long as being at least twice in time as a short. If no longs are found, then all default to shorts.

Subsequently, the translator 418 produces an action code 308 from the sequence of presses and releases of the switch 500. A table 502 as shown in FIG. 5B may be used by the translator 418 to map the collected sequence to an action code 308. For example, in a column 506 of the table 502 is shown multiple sequences. The symbols between the single quotes in the column 506 can be a period, space, or a hyphen. The period denotes a short press, the hyphen denotes a long press, and a space denotes a long release. If no space is shown, a short release is implied.

Suppose a short press is to be translated. The translator 418 finds the short press sequence ‘.’, which is at the second row under the column 506, and maps this sequence to a binary definition “0011111111111111” under a column 508. The translator 418 then uses that binary definition to map to a Code 1 as shown at the second row under a column 504. This Code 1 is the transmitted action code 308 as shown in FIG. 5A. In one embodiment, the action code 308 may be composed of a two-byte field. The first byte indicates which switch on the transmitter 202 was active, and the second byte indicates which action code from the column 504 was translated. Each action code in the column 504 implicitly provides knowledge of the sequence of presses and releases shown in the column 506.

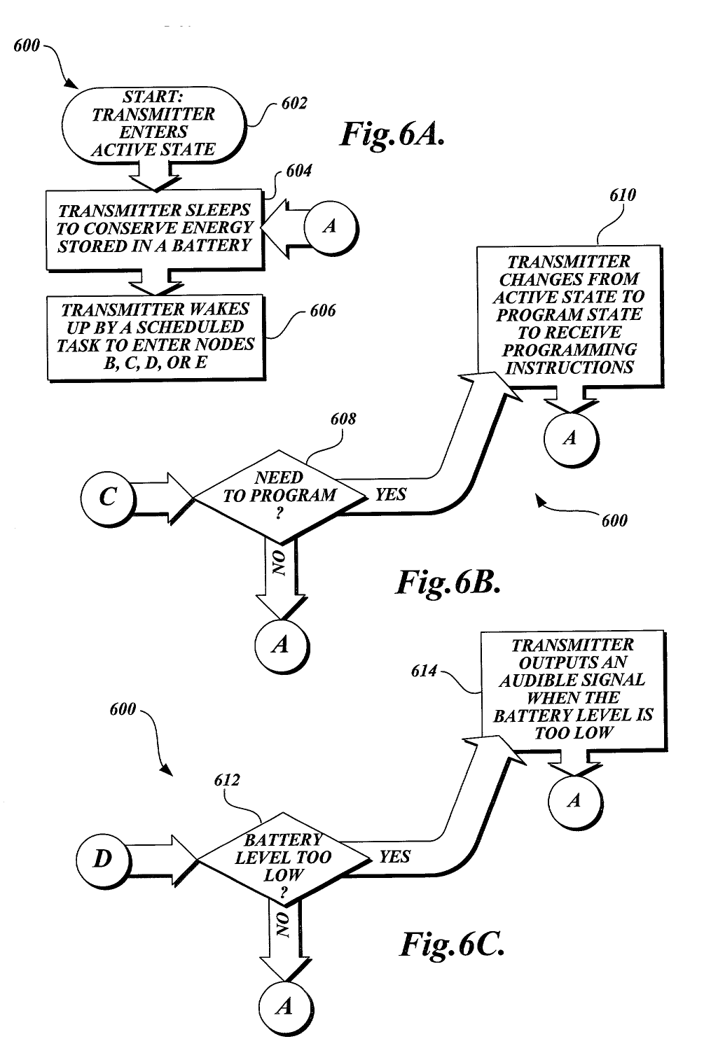

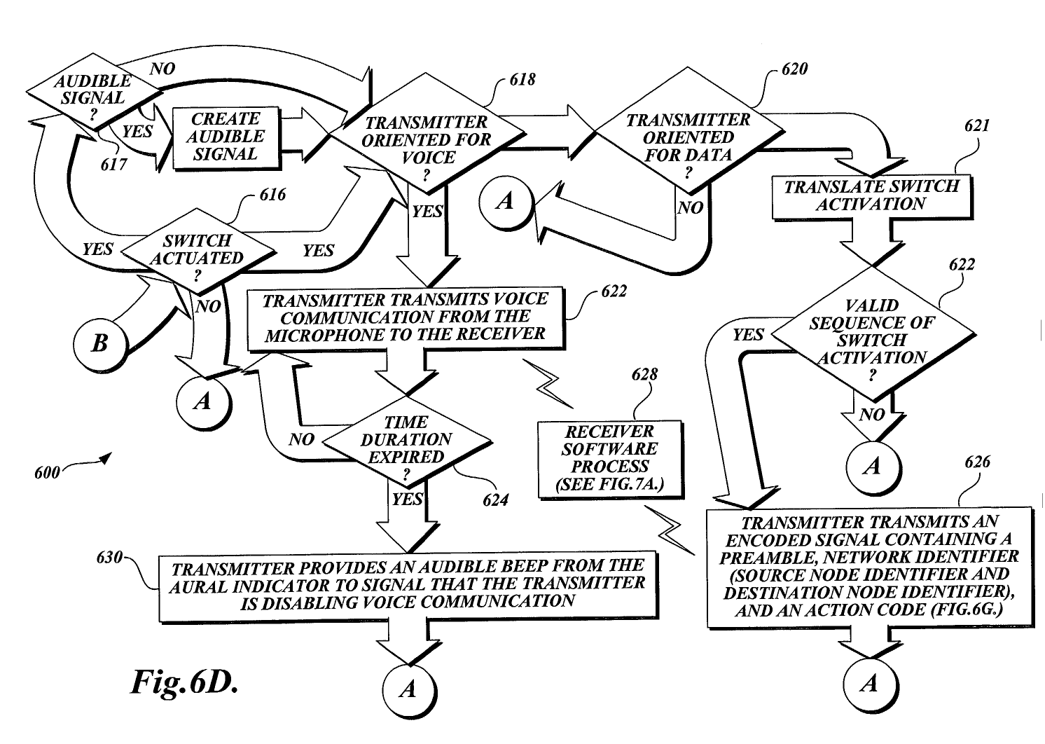

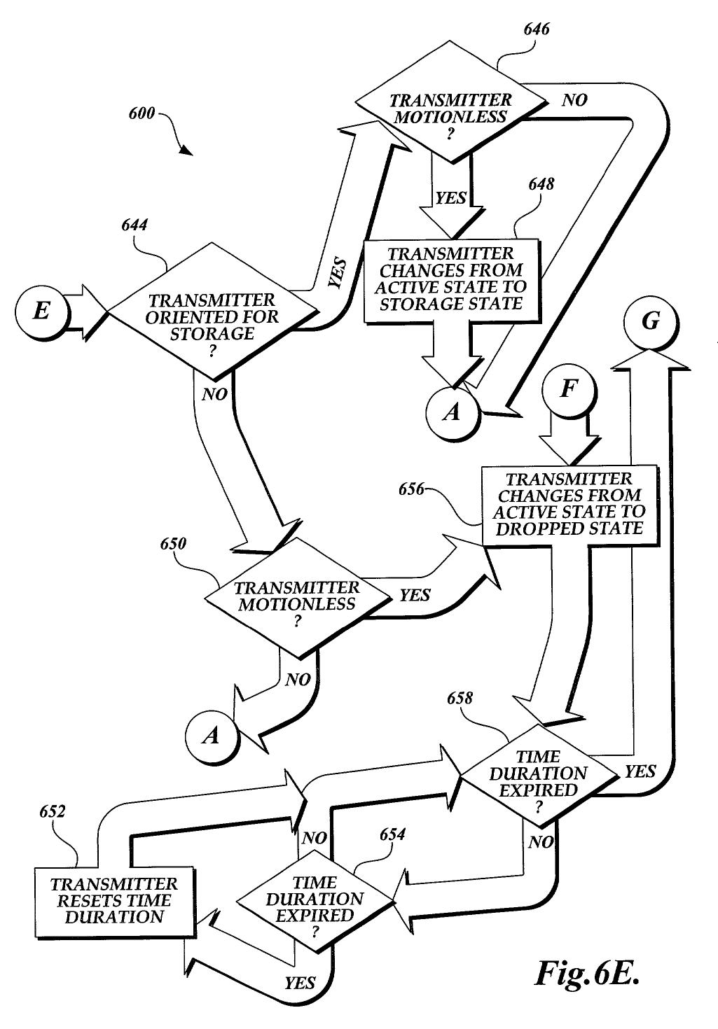

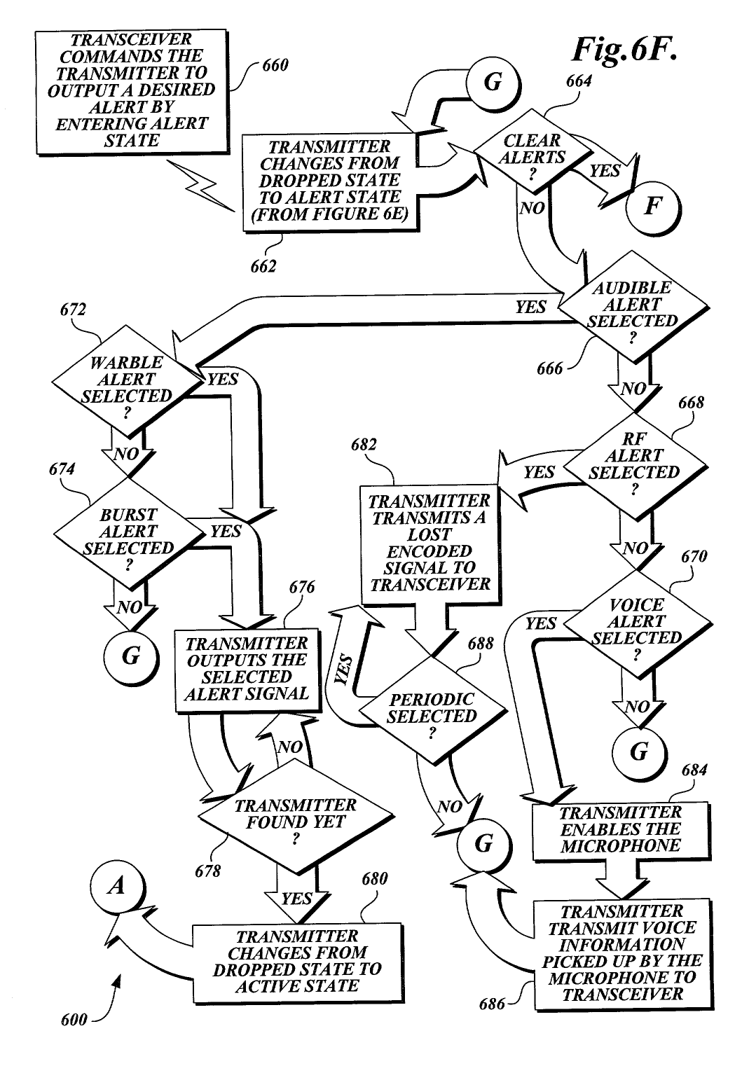

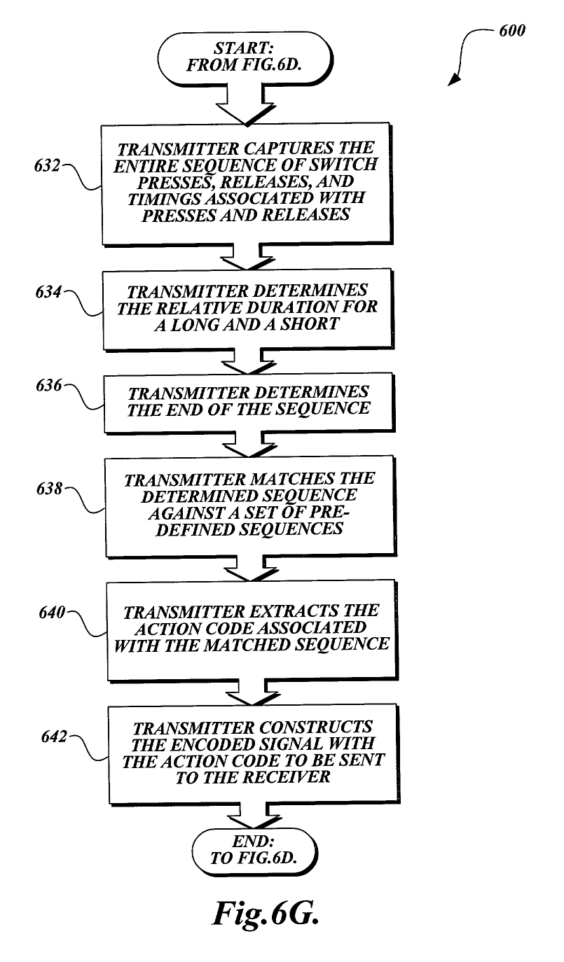

The operation of the transmitter 202 and the preparation of information in the transmitter 202 prior to the communication of such information to either the receiver 204 or the transceiver 216 can be further clarified by referring to a process 600 as shown in FIGS. 6A-6G. At the start of the process 600 the transmitter 202 enters a software state defined as an active state at a start block 602. The active state denotes a normal active operation of the software of the transmitter 202. From this state, the transmitter 202 may change into other states depending on various circumstances, such as an actuation of a switch.

After the transmitter 202 enters the active state, the process 600 proceeds to a block 604 where the transmitter goes into sleep to conserve the energy of the battery. Periodically, the transmitter may be awakened by a scheduled task, at block 606, to execute various subprocesses of the process 600 by entering into one of the nodes B, C, D, or E, as further illustrated in FIGS. 6B-6E.

The transmitter 202 may be woken up by schedule to enter the node C to check a programming pin of the interface 416, as shown in FIG. 6B. From the node C, the process 600 proceeds to a decision block 608. If a programming signal is presented to the programming pin of the interface 416, the decision block 608 enters the block 610 where the transmitter 202 changes from the active state to a program state. In the program state, the transmitter 202 is receptive to programming signals to configure various parameters associated with the transmitter 202, such as the source node identifier, or to calibrate, such as the depth of actuation of the switch 500. When no more programming signals are being presented, the process of programming is complete, and from the block 610 the process 600 enters node A to put the transmitter back to sleep again at block 604. If the answer to the decision block 608 is NO, then the process 600 also returns to the block 604 via the node A to put the transmitter 202 back to sleep until the next scheduled task.

From time to time the transmitter 202 will check the level of its battery. This is accomplished when the transmitter is awakened at block 606 to enter the node D. A decision block 612 is entered by the process 600 to determine whether the level of the battery 412 is too low. If the answer is NO, the decision block 612 proceeds into the node A, and the transmitter 202 is put back to sleep at the block 604. Otherwise, the answer is YES, and the decision block 612 enters the block 614 where the aural indicator 406 outputs an audible signal signifying that the battery level is too low. From here, the process 600 enters the node A to put the transmitter 202 back to sleep at the block 604.

After a switch 500 is pressed, the transmitter 202 wakes up and enters the node B to reach a decision block 616 as illustrated in FIG. 6D. If no switch was actually pressed, the decision block 616 enters the node A and loops back to the block 604 where the transmitter 202 would go to sleep. Otherwise, the process 600 enters a decision block 617 where it is determined whether an audible signal is to be generated. If YES, the process 600 creates the audible signal at a block 619, and enters a decision block 618. If NO at the decision block 617, the process 600 also enters the decision block 618.

The process 600 enters the decision block 618 to determine whether the transmitter 202 is oriented at a range of angles for transmitting voice communication. If the answer to the decision block 618 is YES, the transmitter, at a block 622, enables the microphone, and transmits voice communication received at the microphone 414 to the receiver 204 in the form of a voice signal 208. Although the process 600 continues on to a decision block 624, to show that the voice signal is transmitted to the receiver 204, a lightning symbol is shown emanating from the block 622 to terminate at a block 628 representing the software process of the receiver 204.

To prevent a situation where the transmitter 202 is malfunctioning, such as a stuck switch, forcing the transmitter 202 to indefinitely dominate a channel for transmitting the voice signal 208, a time duration is monitored. If the time duration has expired, then an audible beep is provided through the aural indicator 406, at a block 630, and the process 600 enters the node A to loop back to the block 604 where the transmitter 202 is put to sleep again. If the answer to the decision block 624 is NO, sufficient remaining time is available for the transmitter 202 to continue to transmit voice communication at the block 622.

Returning to the decision block 618, if the answer is NO, the process 600 proceeds to another decision block 620 where the orientation of the transmitter 202 is checked to see if it is in the range of angles for transmitting an encoded signal. If not, the decision block 620 enters the node A and loops back to the block 604. If the answer is YES, a block 621 is entered where the switch action is translated. FIG. 6G describes this process in more detail. Next, a decision block 622 is entered. If the sequence of switch activation is valid, a block 626 is entered. At the block 626, the transmitter forms an encoded signal and transmits the encoded signal to the receiver 204. As already discussed, the encoded signal contains multiple digital portions, such as the preamble 302, the network identifier 306, and the action code 308. Like the block 622, the process 600 continues on from the block 626 to the node A. To show that the encoded signal 206 formed by the block 626 is sent to the receiver 204, a lightning symbol is provided to illustrate this point. After the encoded signal is transmitted, the block 626 enters the node A where it loops back to the block 604. If the answer to the decision block 622 is NO, the process 600 flows to the node A.

The software process described at the block 626 is discussed in greater detail as illustrated by FIG. 6G. When the process 600 enters the YES branch of the decision 620, it proceeds to a block 632. At the block 632, the transmitter 202 uses the translator 418 to capture an entire sequence of switch presses and releases. Also, the timings associated with the presses and the releases are also stored. The process 600 then flows to a block 634 where the transmitter 202 analyzes the timings to determine a duration associated with long presses and long releases and another duration associated with short presses and short releases. To terminate a sequence, the worker using the transmitter 202 releases the switch for a long period of time. With that, at a block 636, the transmitter 202 determines that the sequence has ended, and enters a block 638. At the block 638, the transmitter matches the determined sequence against a set of predefined sequences as shown in the table 502. When a predefined sequence is matched, the transmitter 202 extracts the binary definition associated with the matched sequence. Using the binary definition, the transmitter202 may then map to one of a number of action codes, at a block 640. In the last step, at block 642, the transmitter 202 constructs the encoded signal 206 with the action code to be sent to the receiver 204. Upon exiting from the block 642, the process 600 enters the node A as shown in FIG. 6D to put the transmitter 202 back to sleep again.

Another task for which the schedule may wake the transmitter up to check is the orientation of the transmitter 202. This is accomplished by having the process 600 enter the node E as illustrated in FIG. 6E. The node E directs the process 600 to a decision block 644 where the process 600 determines whether the transmitter is oriented normally at 0 degrees or thereabout. If the answer is NO, the process 600 enters another decision block 650 to check whether the transmitter 202 is motionless. If the answer is NO, the process 600 loops back to the block 604 via the node A. Otherwise, the answer is YES, and the process 600 flows to a block 656 where the transmitter 202 changes from the active state to a dropped state. This signifies that the transmitter is likely lost.

The transmitter 202 can be in the dropped state for a limited duration so that the worker may have a chance to find the transmitter 202 before the transmitter 202 changes to an alert state. Thus, the block 656 flows to a decision block 658 where that time duration is checked for expiration. If the answer is NO, the process 600 flows to another decision block 654. This decision block checks to see whether the time duration should be reset so that the transmitter may continue to be in the dropped state. While in the dropped state, the transmitter 202 may be more receptive to process commands coming from a transceiver 216. In this way, the transceiver 216 may interact continuously with the transmitter 202 so that the transceiver 216 may locate the transmitter 202. If the answer to the decision block 654 is NO, the process 600 loops back to the decision block 658. Otherwise, the answer is YES from decision block 654, and the process 600 flows to a block 652 where the transmitter 202 resets the time duration. From the block 652, the process 600 loops back to the decision block 658 to check the expiration of the time duration again. If the time duration expired as determined by the decision block 658, the process 600 flows to a node G as further illustrated in FIG. 6F.

Returning to the decision block 644, the process 600 flows to a decision block 646 when the transmitter 202 is oriented for storage. The decision block 646 determines whether the transmitter 202 is motionless. If it is not, the transmitter 202 is likely to be tethered to the worker's belt, and the transmitter 202 is in its normal position. Thus, the answer to the decision block 646 is NO, and the process 600 progresses back to the main loop at block 604 via the node A. If the transmitter is motionless, then a block 648 is entered. The transmitter, at the block 648, changes from the active state to a storage state. The storage state denotes that the transmitter 202 is stored in a charging unit so that the battery 412 is recharging. From the block 648, the process 600 enters the node A to loop back to the block 604.

The node G, at the FIG. 6E, is the entry point for the continuation of the process 600 illustrated in FIG. 6F. From the node G, the process 600 enters a block 662. At the block 662, the transmitter 202 changes from the dropped state to an alert state. Although the transmitter may make this transition to the alert state because of an expiration of a time duration, as illustrated in FIG. 6E, the transmitter 202 may also enter the alert state because the transceiver 216, at a block 660, commands the transmitter 202 to make the transition.

After the state of the transmitter 202 has changed to an alert state, the process 600 enters a decision block 664 to determine whether it is to clear all alerts. If a command has been received by the transmitter 202 from the transceiver 216 to clear all alerts, the process 600 flows to the node F and enters the block 656 again, as shown in FIG. 6E. Typically, the transceiver would clear all the alerts of the transmitter 202 so that the transmitter 202 may pay attention and receive commands from the transceiver 216. If the answer to the decision block 664 is NO, a decision block 666 is entered. The decision block 666 determines whether an audible alert is selected. If the answer is YES to the decision block 666, the process 600 progresses to determine whether a warble alert is selected at a decision block 672.

A warble alert is a continuously generated tone alternating from one frequency to another, at a rate that resembles a siren. The warble alert of the transmitter 202 may be enabled by the transceiver 216 when actively searching for the transmitter 202. If the answer is NO to the decision block 672, the process 600 enters a decision block 674 to determine whether a burst alert is selected. If the answer to the decision block 674 is NO, the process enters the node G and loops back to the block 662. If the answer is YES for either the decision block 672 or the decision block 674, a block 676 is entered where the transmitter 202 outputs the selected alert signal through the aural indicator 406. After the transmitter 202 has output the selected alert signal at the block 676, the process 600 enters a decision block 678 to determine whether the transmitter 202 has been found yet. If the transmitter 202 has not been found, the process 600 loops back to the block 676 so that the selected alert signal can continue to be output. Otherwise, the transmitter has been found and the process 600 progresses to a block 680, where the transmitter 202 changes from the dropped state back to the active state. Thereafter, the process 600 enters the node A to loop back to the block 604 illustrated in FIG. 6A.

Returning to the decision block 666, if the audible alert is not selected, a decision block 668 is entered. If RF (radio frequency) alert is selected, the process 600 enters a block 682 where the transmitter 202 transmits a “lost” encoded signal 218 to the transceiver 216. Next, a decision block 688 is entered to check whether the transmitter 202 is supposed to periodically transmit the “lost” encoded signal 218. If the answer is YES, the block 682 is entered once again after a certain period to transmit the “lost” encoded signal 218 to the transceiver 216. Otherwise, the process 600 enters the node G and loops back to the block 662.

Returning to the decision block 668, if the answer is NO, a decision block 670 is entered by the process 600 to determine whether voice alert is selected. If NO, the process 600 loops to the block 662 via the node G. Otherwise, the process 600 flows to a block 684 to enable the microphone 414 of the transmitter 202. The transmitter 202, at a block 686, picks up noise as well as information received by the microphone, and transmits such information to the transceiver 216. The voice alert allows voice or audio information to be sent over to the transceiver 216. This allows searchers to gain additional information on the position of the transmitter 202 by making noise in various directions and listening for the created noise over the transceiver 216.

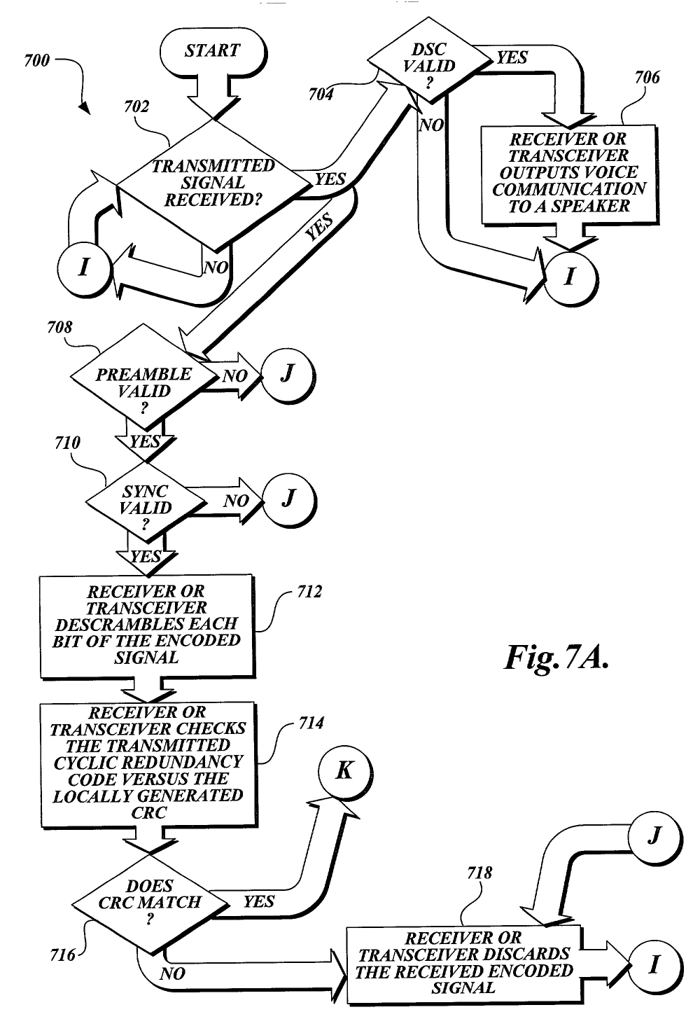

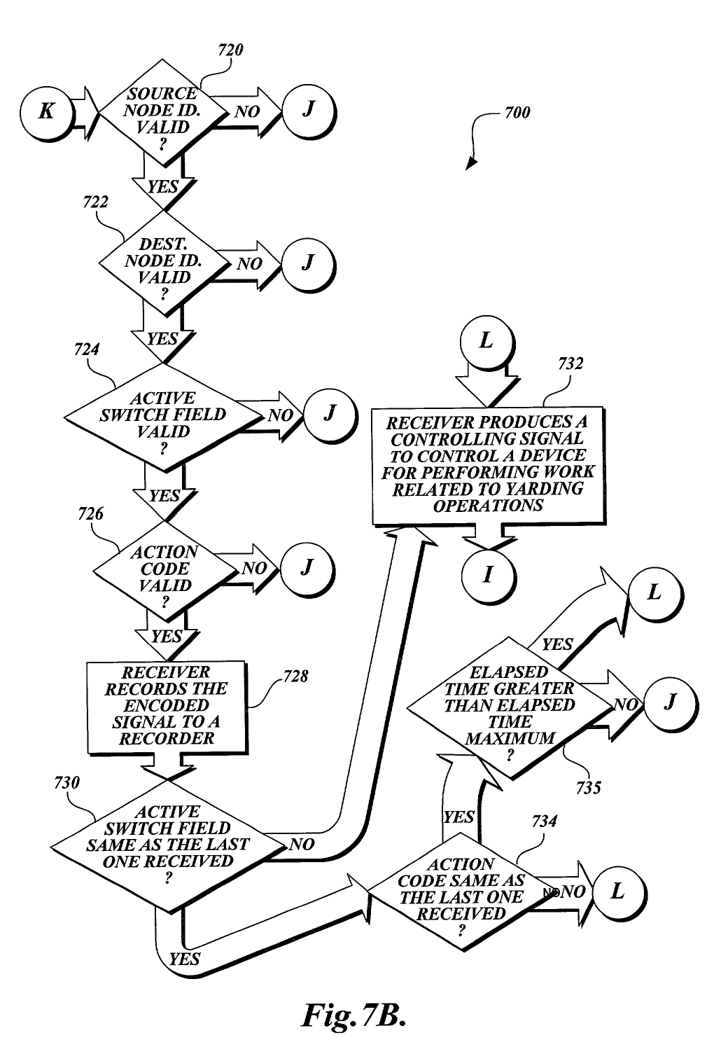

The receiver 204 has a software process 700, as illustrated in FIG. 7A, that waits to process a transmitted signal sent by the transmitter 202. Although this transmitted signal is likely to be from the transmitter 202, noise and other competing signals, such as cellular phone signals, may also be picked up by the receiver 204. Thus, the process 700 focuses on eliminating these invalid signals so that the receiver 204 may process signals that are transmitted from the transmitter 202. The process 700 begins at a decision block 702 where unless a transmitted signal is received, a node I is entered, which simply loops back to the decision block 702 again. Otherwise, if the answer to the decision block 702 is YES, a decision block 704 is entered where the process 700 checks to see whether the digital squelch code 312 is valid. A valid digital squelch code indicates that the transmitter 202 has just transmitted voice communication, and therefore, a block 706 is entered so that the receiver 204 may output the voice communication to an audible signaling device 214 or other devices. From there, the process 700 enters the node I to loop back to the decision block 702 to wait for the next transmitted signal. An invalid digital squelch code would lead the process 700 to enter the NO branch from the decision block 704 to come to the node I where the process 700 loops back to the decision block 702.

A decision block 708 is also entered by the process 700 if the answer to the decision block 702 is YES because the execution branch beginning with the decision block 704 and the execution branch beginning with the decision block 708 operate in parallel. At the decision block 708, the preamble of the encoded signal is checked. An invalid preamble branches the process 700 to enter the node J. And from the node J, a block 718 is entered where the receiver 204 discards the received encoded signal.

If the answer to the decision block 708 is YES, the preamble of the received encoded signal is valid. In that case, the software process 700 proceeds to another decision block 710 where a bit pattern of the sync 304 of the encoded signal 206 is checked. If the sync 304 is invalid, then the encoded signal is either a noise signal or an interfering signal. Next, the process 700 enters the node J where the block 718 discards the noise signal or the interfering signal. When either the process 700 flows through the node J from the decision block 708 or the decision block 710, the block 718 is entered, and subsequently, the node I is entered so that the process 700 can wait to receive more transmitted signals at the decision block 702.

If the sync is valid, the process 700 flows from the decision block 710 to a block 712 where the receiver 204 descrambles each bit of the encoded signal following the sync. The receiver 204 then checks the transmitted cyclic redundancy code versus the locally generated cyclic redundancy code on the receiver 204, at a block 714. If the cyclic redundancy code does not match, the process 700 flows from a decision block 716 to the block 718 where the receiver discards the encoded signal. Subsequently, the process 700 will loop back through the decision block 702 via the node I to wait for further transmitted signals. If the cyclic redundancy code does match between the transmitted code and the locally generated code, the process 700 flows from the decision block 716 to the node K, which is further described in FIG. 7B.

The portions of the process 700 as described in FIG. 7A are concerned about recognizing a valid voice signal or a valid encoded signal. If the process 700 is able to flow through the node K, it is very likely that the encoded signal is a valid signal coming from the transmitter 202. However, there are additional checks that the encoded signal undergoes, as illustrated in FIG. 7B.

From the node K the process 700 enters a decision block 720 to begin to check the validity of the network identifier 306 of the encoded signal. As discussed above, the network identifier 306 includes a source node identifier of the transmitter 202 transmitting the encoded signal and a destination node identifier, which identifies the receiver 204 that is to receive the encoded signal. Returning to the decision block 720, if the answer is NO, this means that the source node identifier of the transmitter 202 is not among a set of transmitters recognized by the receiver 204, and thus, the process 700 enters the node J to flow back to the block 718 where the receiver 204 discards the encoded signal. Subsequently, the process 700 flows through the node I and returns to the decision block 702 so that the process 700 can wait for further transmitted signals to process.

If the source node identifier is valid, the decision block 720 proceeds to a decision block 722 so that the process 700 can verify whether the encoded signal is meant for the receiver 204. If the destination node identifier in the encoded signal is different from the predetermined destination node identifier configured for the receiver 204, then once again the process 700 flows back to the block 718, via the node J, where the encoded signal is discarded. Subsequently, the process 700 flows back to the decision block 702 via the node I to await for further transmitted signals. If the destination node identifier is valid, then the encoded signal is meant for the receiver 204.

Next, the process 700 enters a decision block 724. The process 700 checks for errors in the active switch field of the encoded signal. The active switch field denotes the one switch that was actuated. If two or more switches were set in the active field, then the decision block 724 branches to enter the node J and progresses to the block 718 where the received encoded signal is discarded. From there, the process 700 returns to the decision block 702 via the node I. Otherwise, the decision block 724 branches to a decision block 726 where the action code of the encoded signal is checked. If the action code is not valid, then the process 700 branches to the node J and to the block 718 where the receiver 204 discards the received encoded signal. Next, the node I is entered by the process 700 to return to the decision block 702. If the action code is valid, the process 700 from the decision block 726 progresses to a block 728 where the recorder 212 records the encoded signal in the history file.

To prevent undesired repeated encoded transmissions, a decision block 730 is provided to check whether the active switch field is the same as the active switch field of the last received encoded signal. In circumstances, repeated encoded encoded tranmissions are desired to improve the likelihood of reception. If it is the same, then the answer to the decision block 730 is YES, and the process 700 flows to a decision block 734. Although the process 700 could have discarded the encoded signal if the answer to the decision block 730 were YES, a non-duplicating signal may contain the same active switch field as the last received encoded signal. To make sure this has not occurred, therefore, the action code of the encoded signal is also checked against the action code of the last received encoded signal.

If the answer to the decision block 734 is YES, the process 700 flows to a decision block 735 where the elapsed time between encoded signal packets is compared against the elapsed time maximum. If the elapsed time is less than the maximum, it is likely that the received encoded signal is a duplicate of the last received encoded signal, and the process flows to node J, block 718; otherwise, if the elapsed time is greater than the maximum time, the process flows to node L, block 732.

If the answer to either the decision block 730 or the decision block 734 is NO, then a block 732 is entered by the process 700. At the block 732, the receiver produces a controlling signal from the action code to control a device for performing work related to yarding operations, such as activating a yarder or an audible signaling device 214.

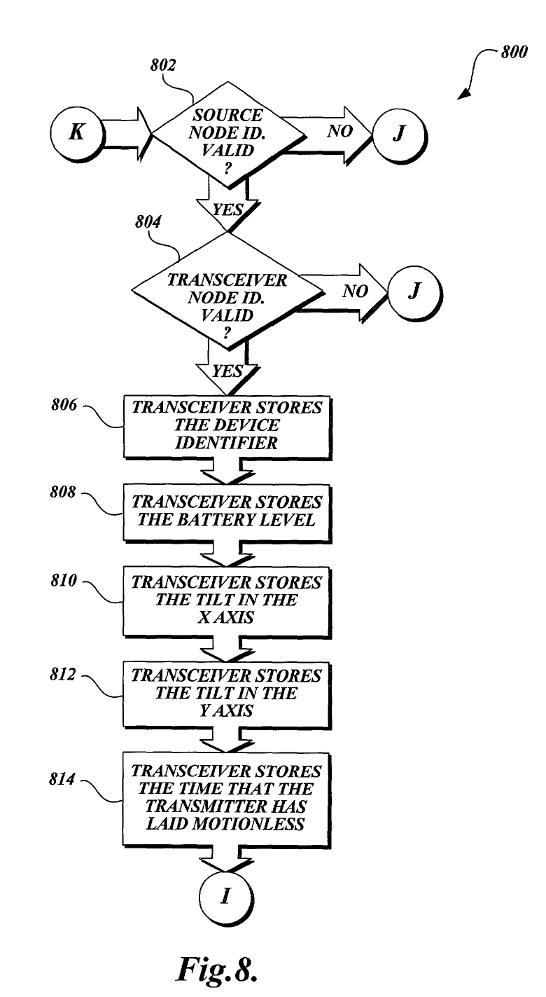

As discussed above, the transceiver 216 can be used to find a “lost” transmitter 202. One of the techniques that the transceiver 216 may use includes commanding the transmitter 202 to output the “lost” encoded signal 218. A number of the portions of the “lost” encoded signal 218 are similar to the encoded signal 206, such as the preamble, the sync, and the cyclic redundancy code. Thus, a number of steps of the process 800 are similar to the process 700. For the sake of brevity, FIG. 8 illustrates a portion of the process 800 while the remaining portions of the process 800 are similar to those discussed above with respect to FIG. 7A. Therefore, the discussion related to FIG. 7A is incorporated here in full for the process 800. For example, if the last encoded signal contains a valid preamble, a valid sync, and the cyclic redundancy code is matched, then the process 800 enters the node K to come to a decision block 802. At the block 802, the source node identifier of the “lost” encoded signal is checked. If the source node identifier of the “lost” encoded signal is not among the source node identifiers recognized by the transceiver 216, the process 800 enters the node J, and proceeds to the block 718 where the transceiver 216 discards the received “lost” encoded signal. After that, the process 800 enters the decision block 702, via the node I, to wait for further transmitted signals from the transceiver 216.

If the source node identifier is valid, the process 800 proceeds from the decision block 802 to a decision block 804 where the transceiver node identifier contained in the “lost” encoded signal is checked. If the transceiver node identifier is not the same as the transceiver node identifier of the transceiver 216, the process 800 flows through the node J to the block 718 where the “lost” encoded signal is discarded. Then, the process 800 enters the node I to flow to the decision block 702 where the process 800 awaits for further transmitted signals from the transceiver 216.

If the answer to the decision block 804 is YES, the “lost” encoded signal is meant for the transceiver 216. Thus, the process 800 flows from the decision block 804 to a block 806 where the transceiver 216 stores the device identifier 324. The remaining pieces of information of the “lost” encoded signal 218 are also stored by the transceiver, such as the battery level 326 at a block 808, the tilt in the x-axis 328 at a block 810, the tilt in the y-axis 330 at a block 812, and the time 332 that the transmitter 202 has laid motionless at a block 814. This information may be used by the transceiver 216 to locate the transmitter 202. After storing the above information, the process 800 returns to the decision block 702 via the node I to wait for further transmitted signals from the transmitter 202.

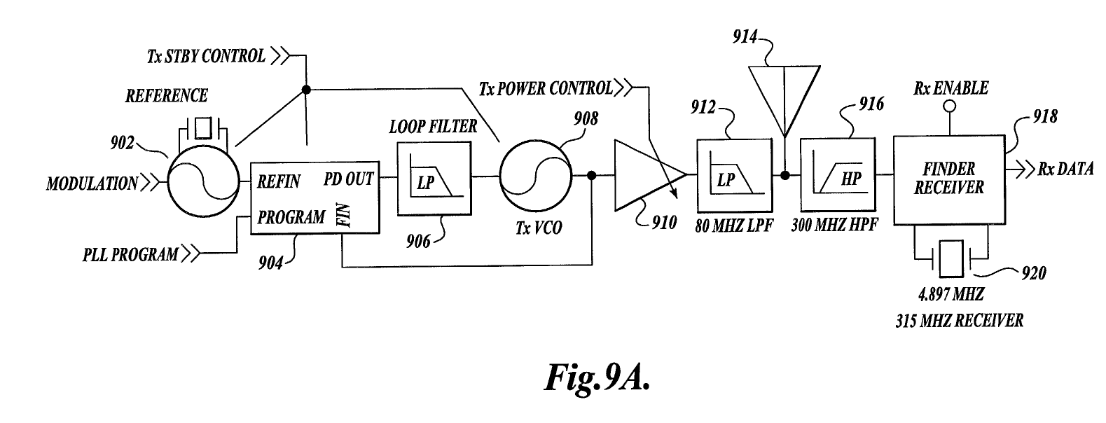

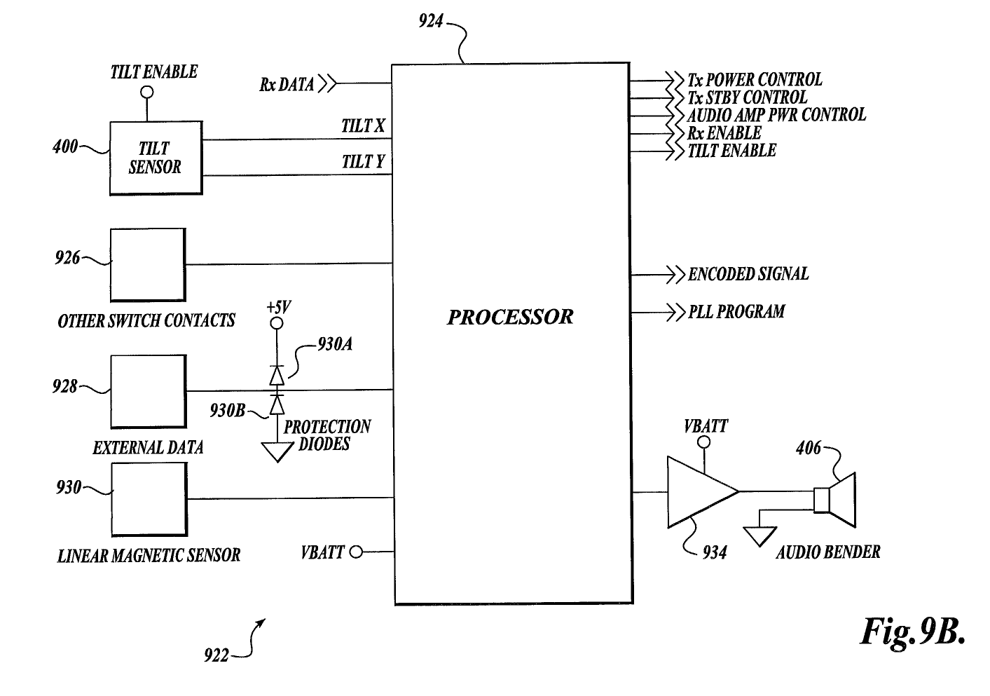

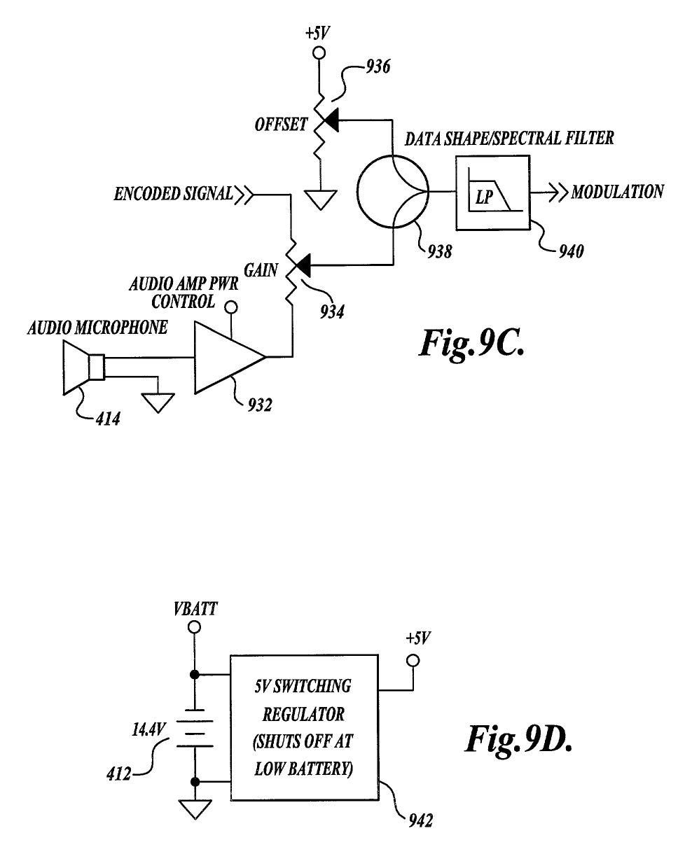

FIG. 9A illustrates a circuit block diagram of a radio frequency system 900 for the transmitter 202. The system includes a reference crystal oscillator 902 for generating a reference frequency. The crystal oscillator 902 may receive either an encoded signal or a voice signal for modulating the reference frequency to produce a modulated signal. The modulated signal enters a component 904 where the modulated signal is multiplied with an oscillated encoded signal (to be described later) to produce a voltage signal having a magnitude and sign that are proportional to the phase difference between the modulated signal and the oscillated encoded signal. The component 904 may also receive a phase-locked loop programming signal to change the frequencies of the oscillated encoded signal thereby shifting from one channel to another channel of the frequency spectrum for communicating data and voice signals.

The voltage signal that is indicative of the phase difference is presented to a loop filter 906. The loop filter 906 low-pass filters the voltage signal to produce a filtered voltage signal. This filtered voltage signal is input to a voltage-controlled oscillator 908 to adjust the frequency by which the voltage-controlled oscillator oscillates the modulated signal to produce an oscillated encoded signal. A portion of the oscillated encoded signal is fed back to the component 904. The operation of the reference oscillator 902, the component 904, and the voltage-controlled oscillator 908 is controlled by a signal titled Transmitter Standby Control Signal (Tx Stby Control). Unless this Transmitter Standby Control Signal is at a predetermined voltage level, the reference oscillator 902, the component 904, and the voltage-controlled oscillator 908 may not operate, thereby allowing the energy of the battery 412 of the transmitter 202 to be conserved until the transmitter 202 is ready to transmit a signal. The rest of the oscillated encoded signal enters a radio-frequency power amplifier to produce an amplified encoded signal. The reference oscillator 902, the component 904, the loop filter 906, and the voltage-controlled oscillator may be referred to collectively as a frequency synthesizer.

The radio-frequency power amplifier 910 will not operate unless a signal titled Transmitter Power Control Signal (Tx Power Control) is at a predetermined level. This inhibits noise from being transmitted by the transmitter 202 that may inadvertently enter the radio-frequency power amplifier 910. A harmonic cleansing filter 912 receives the amplified encoded signal to low-pass filter it to produce a cleansed encoded signal, which is about 80 MHz. The harmonic cleansing filter 912 discards a number of undesired harmonics associated with the amplified encoded signal. Beyond the harmonic cleansing filter is an antenna 914 where the cleansed encoded signal is radiated so that the receiver 204 or the transceiver 216 may receive the transmitted signal.

Also coupled to the antenna 914 is a high-pass filter 916. The purpose of the high-pass filter 916 is to block the cleansed encoded signal produced by the harmonic cleansing filter 912 from entering into circuit stages that are subsequent to the high-pass filter 916. Although the purpose of the transmitter 202 is to transmit signals to the receiver 204, it may receive commands from the transceiver 216, via the antenna 914. The signal path for the transmitter 202 to receive commands from the transceiver 216 is differentiated from other signal paths within the transmitter 202 by the high-pass filter 916. The high-pass filter 916 can be configured to pass any high frequency, such as greater than about 300 MHz.

When a signal passes through the high-pass filter 916, it enters a finder receiver 918. The finder receiver 918 is coupled to a crystal oscillator 920 that can provide a reference frequency at any suitable frequency, such as at 4.897 MHz, so that the finder receiver 918 may receive commands from the transceiver 216 at about 315 Mhz or at any other suitable frequency. If the finder receiver 918 is enabled by a signal titled Receiver Enable Signal (Rx Enable), then it may demodulate the signal passing through the high-pass filter 916 to produce a Received Data Signal (Rx Data). The Received Data Signal carries information from the transceiver 216 to be processed by the transmitter 202.

FIG. 9B illustrates a circuit block diagram of a controlling system 922 for the transmitter 202. The controlling system 922 includes a processor 924. The processor 924 contains the software process 600 as described above in FIGS. 6A-6G. When the processor 924 is enabled, the processor 924 executes the process 600. The processor 924 receives a number of signals for processing, and in response the processor 924 may produce a number of signals. The processor 924 is adapted to receive the Received Data Signal coming from the finder receiver 918. In response to this signal, the processor 924 may output a “lost” encoded signal so that the transmitter 202 may be found. Although, in one embodiment, the processor 924 needs not rely on the Received Data Signal to output the “lost” encoded signal but may automatically produce this signal when the state of the transmitter 202 enters the alert state. The two-axes tilt sensor 400 produces two signals, tilt x and tilt y. These two signals are presented to the processor 924 so as to determine the orientation of and whether the transmitter 202 is in motion. These two signals will be provided to the processor 924 only when the two-axes tilt sensor 400 is enabled by a Tilt Enabler Signal (Tilt Enable). This signal is produced by the processor 924.

The processor 924 is also adapted to receive actuations of a switch 500 coming from switch contacts 926. If the switch 500 is a magnetic switch, the processor 924 receives the actuation signals through a linear magnetic sensor 930. The processor 924 is powered by the power signal (Vbatt) of the battery 412.

To program the transmitter 202, programming signals may be provided at the interface 416. These programming signals may enter the processor 924 through external data port 928. To prevent electrostatic discharge from damaging the processor 924, several protection diodes, such as diodes 930a, 930b are provided.

Also coupled to the processor 924 is an amplifier 934 to amplify audio signals produced by the processor 924 so that the aural indicator 406 may provide feedback to a user or to indicate changes in the states of the transmitter 202.

The processor 924 produces a number of signals. For example, the Transmitter Power Control Signal (Tx Power Control) enables or disables the radio-frequency power amplifier 910; the Transmitter Standby Control Signal (Tx Stby Control) disables or enables the frequency synthesizer; an Audio Amplifier Power Control Signal (Audio Amp Pwr Control) enables or disables the audio amplifier 932; the Receiver Enable Signal (Rx Enable) enables or disables the finder-receiver 918; and the Tilt Enable Signal (Tilt Enable) disables or enables the two-axes tilt sensor 400.

There are other signals that are produced by the processor 924, such as the Phase-Locked Loop Programming Signal (PLL Program), which is presented to the component 904, for changing the channel on which the transmitter 202 transmits information. The processor 924 also produces an encoded signal, such as signal 206 or 218. Audio alerts and other user interface sounds may be produced by the processor 924 to be amplified by the amplifier 934. Subsequently, an aural indicator 406, such as an audio bender or a piezoelectric, reproduces the sound.

FIG. 9C illustrates a circuit that multiplexes between an encoded signal and an audio signal. The voice signal is picked up by the audio microphone 414 and amplified by an amplifier 932. The amplified voice signal enters a potentiometer 934 at one node. At the other node of the potentiometer 934 is the encoded signal. Depending on whether the encoded signal or the audio signal is active, the potentiometer 934 provides a gain to that signal. That signal enters a combiner 938 to be combined with an offset signal produced by a potentiometer 936. The combined signal is then presented to a low-pass filter 940 so as to shape away the harshness of the sharp transition of a digital signal to produce either an encoded signal or a voice signal ready to modulate the reference signal produced by the referenced crystal oscillator 902.

FIG. 9D illustrates a power circuit for providing power to the processor 924. The power circuit includes a battery 412, which is regulated by a regulator 942. The regulator 942 is coupled in parallel across the battery 944 to produce a five-volt signal and a power signal (Vbatt) to the processor 924. The power signal is provided to both the processor 924 as well as the amplifier 934, discussed in FIG. 9B.

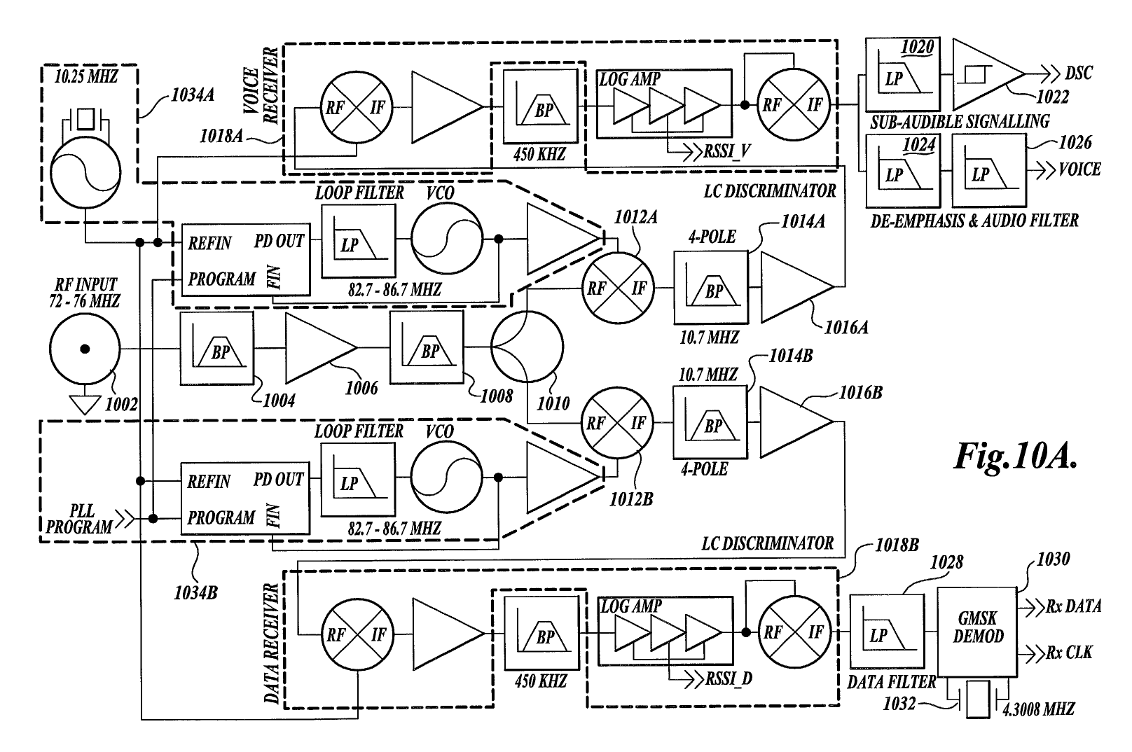

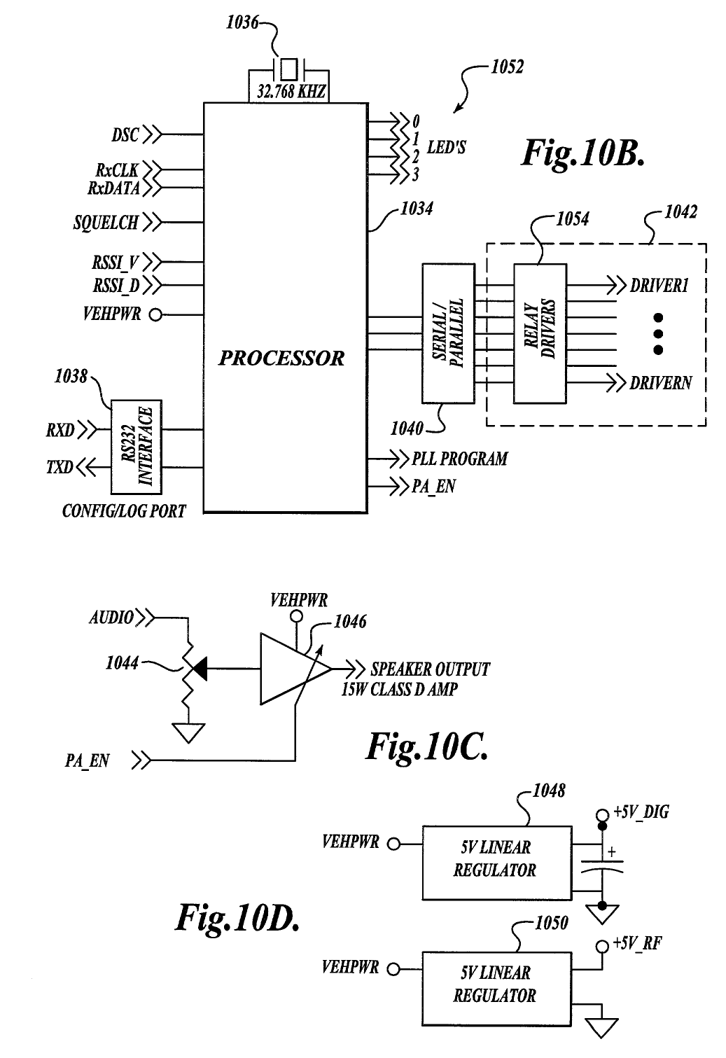

The receiver 204 includes a radio-frequency circuit 1000, as illustrated in FIG. 10A; a controller circuit 1052 and a relay circuit 1042 as illustrated in FIG. 10B; a speaker amplifier as illustrated in FIG. 10C; and two power circuits as illustrated in FIG. 10D.

The radio-frequency circuit 1000 receives a transmitted signal at a radio-frequency input port 1002. The transmission frequency range of the transmitted signal is greater than about 72 Mhz and less than about 76 MHz. The radio-frequency input port 1002 presents the transmitted signal to a front-end stage, which comprises a band pass filter 1004, a radio-frequency amplifier 1006, and another band pass filter 1008. In one embodiment, each of the band pass filters 1004, 1008 is a magnetically coupled band pass filter, which is tunable by deformation of the twin coils within a shielded enclosure. Because the band pass filters 1004, 1008 are magnetically coupled, no direct electrical connection between the antenna and the amplifier 1006 is necessary, thereby minimizing issues related to surge voltages and other undesirable effects associated with an external antenna. The band pass filters 1004, 1008 may be designed to have an asymmetric response, rejecting better at low frequencies than at high frequencies.

After being processed by the front-end stage of the radio-frequency circuit 1000, the transmitted signal enters a splitter 1010. The splitter 1010 sends the transmitted signal into two paths, namely a voice path and a data path. The processing components after the splitter 1010 of the radio-frequency circuit 1000 may be manufactured similarly so as to take advantage of economies of scale. The radio-frequency circuit 1000 includes two down-converters, namely down-converter 1012a in the voice path and down-converter 1012b in the data path. Each down-converter 1012a, 1012b may handle the splitted transmitted signal simultaneously. The down-converters 1012a, 1012b may consists a passive double-balanced mixer. One advantage of using this type of mixer includes the optimization of intermodulation performance as well as minimizing the circuit board area and cost. To further enhance the intermodulation performance of the down-converters 1012a, 1012b, the output of the down-converters may be terminated with a corresponding diplex filter. Each of the down-converters 1012a, 1012b uses outputs from corresponding frequency synthesizers 1034a, 1034b to down-convert the transmitted signal to about 10.7 Mhz.

The down-converted signals are presented to two intermediate frequency strip stages to cleanse the down-converted signal. The intermediate frequency strip stage in the voice path includes a four-pole filter 1014a for band pass filtering the down-converted signal. This intermediate frequency strip stage also includes an intermediate frequency amplifier for amplifying the filtered signal produced by the four-pole filter 1014a. Similarly, the other intermediate frequency strip stage in the data path includes the four-pole filter 1014b as well as an intermediate frequency amplifier 1016b. The resulting signal produced by the intermediate frequency strip stage in the data path is presented to a receiver stage 101 8a. Similarly, the resulting signal from the intermediate frequency strip stage in the data path is also introduced to another receiving stage 1018b. Both receiving stages 1018a, 1018b provide four types of functions, which include down-converting to another lower intermediate frequency, at about 450 kHz; further amplification; signal strength monitoring; and FM demodulation. The receiving stages 101 8a, 101 8b are considered well known, and will not be further discussed. Both receiving stages 101 8a, 101 8b use six-pole filters to ensure that a frequency range of about 450 kHz is processed. Another signal provided by the receiving stage 1018a is a Voice Signal Strength Signal titled RSSI_V. And the other receiving stage 1018b also provides a Data Signal Strength Signal titled RSSI_D signal.

Both the receiving stages 1018a, 1018b produce demodulated signals. The demodulated signal in the voice path enters a low pass filter 1020 and a Schmitt trigger 1022 to produce a digital squelch code (DSC). The demodulated signal in the data path is also input into a deemphasis filter 1024 and a low pass filter 1026 to recover the voice communication originated at the transmitter 202.

The demodulated signal from the receiving stage 1018b in the data path enters a low pass filter 1028 and subsequently enters a Gaussian Minimum Shift Key demodulator 1030. A crystal oscillator 1032 with an operating frequency at about 4.3008 MHz is coupled to the Gaussian Minimum Shift Key demodulator 1030 to aid in the recovering of the encoded signal and a clock associated with the encoded signal.

FIG. 10B illustrates a controller circuit 1052, which includes a processor 1034. The processor 1034 provides the main computing power for the receiver 204. It also stores and executes the software process 700 as described with respect to FIGS. 7A and 7B. Various software parameters within the processor 1034 may be configured via an RS232 interface port 1038. This interface port 1038 may receive programming data (RXD) and it may also transfer data (TXD) from the processor 1034.

The processor 1034 is powered by a power signal (VehPwr), which may come from the device it is controlling, such as a motorized carriage. The processor 1034 is also adapted to receive the two signal strength indicator signals, namely RSSI_V signal and RSSI_D signal. A squelch signal is also input into the processor 1034 to allow the processor to check the digital squelch code extracted from the transmitted signal. If the transmitted signal is an encoded signal, then both the clock of the encoded signal (RxClk) and the data of the encoded signal (RxData) are input into the processor 1034 to extract action codes and other information.

A DSC signal is extracted from a voice signal and is presented to the processor 1034 for comparison against the squelch signal stored in the controller circuit 1052 or other places on the controller circuit 1052. A crystal oscillator 1036 provides a suitable reference frequency, such as 32.768 kHz, to clock the processor 1034. A number of LED signals are also provided by the processor 1034, and they can be coupled to LEDs. These LED signals can be used to indicate the internal states and operations of the processor 1034.

As discussed above, when an action code is extracted from the encoded signal, the action code can be converted into a controlling signal to control a number of devices for performing work related to yarding operations. The controlling signal may be serial in nature. Thus, to convert the serial controlling signal to a parallel form, a serial to parallel converter 1040 is provided. The converted signal is then sent to the relay circuit 1042 where it is received by a relay driver circuit 1054 to produce a particular driver signal to control a piece of yarding machinery.

The processor 1034 also produces a Phase-Locked Loop Programming signal (PLL Program) that is input into both the frequency synthesizers 1034a and 1034b so as to allow the radio-frequency circuit 1000 to select a particular channel to receive and process the transmitted signal. Another signal that is produced by the processor 1034 is a Power Amplifier Enable Signal (PA_En). This Power Amplifier Enable Signal allows the processor 1034 to control whether the power amplifier for a speaker is enabled or disabled.

FIG. 10C illustrates a circuit block diagram for processing an audio signal, which can be either a whistle signal or an extracted voice communication (Audio) from a voice signal. The audio signal is input into a potentiometer 1044. The potentiometer 1044 then presents an audio signal to an audio amplifier 1046 for amplification. In one embodiment, this power amplifier 1046 may be a 15-watt class D amplifier. The power amplifier 1046 is enabled when the Power Amplifier Enable Signal, as produced by the processor 1034, is at a predetermined level. Additionally, the power amplifier 1046 will be enabled when the power signal is provided to it. The result coming out from the power amplifier 1046 is an amplified audio signal ready to be broadcast by the audio signaling device 214.

The power for the receiver 204 may comprise two separate sources of supplies. FIG. 10D illustrates a 5-volt linear voltage regulator 1048 for providing a power source to the controller circuit 1052. Another 5-volt linear voltage regulator 1050 provides power to the radio-frequency circuit 1000, as described in FIG. 10A. In this way, the power signal to circuit 1052, 1000 is kept clean of any parasitic feedbacks that may affect the processing of radio-frequency transmitted signals.

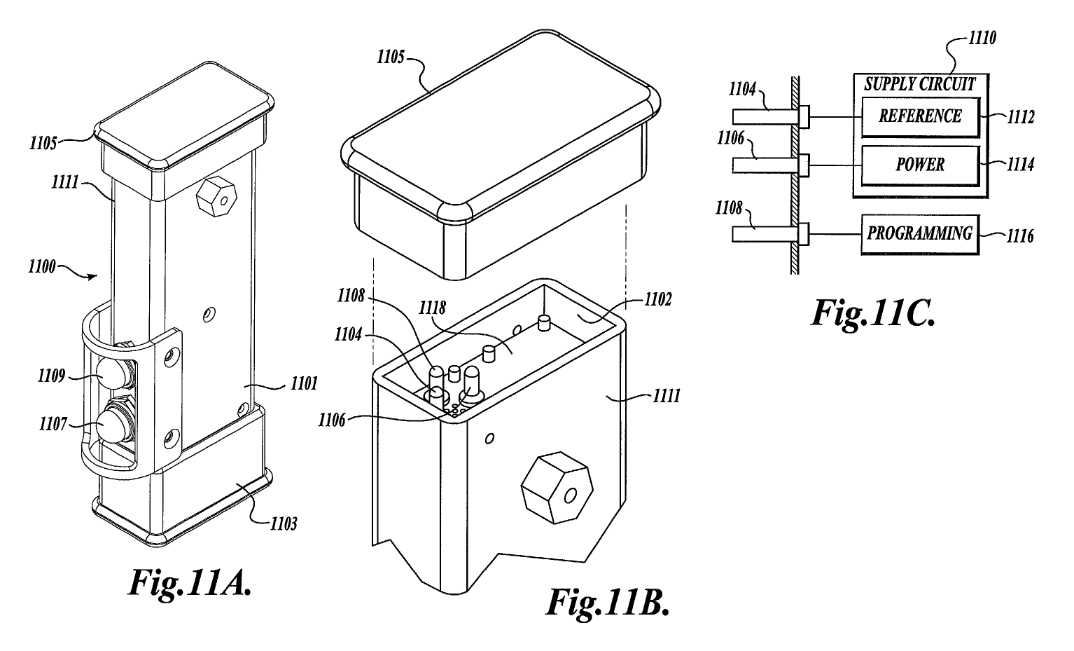

FIG. 11A is an isometric view of a transmitter 202 that includes a top portion 1101 being capped by a first cover 1103 and a bottom 1111 being capped by a second cover 1105. The transmitter 202 includes an elongated member 1100 being integrally connected to the top portion 1101 and the bottom 1111. Two switches 1107, 1109 are shown to allow a worker to enter a command to the transmitter 202.

FIG. 11B is another isometric view showing the bottom 1111 of the transmitter 202 with the second cover 1105 removed. The bottom of the transmitter 202 includes an open chamber 1102 to allow the transmitter 202 to be engagingly fitted into a charging/programming unit (not shown). The open chamber 1102 has a floor 1118. Within a certain periphery of the floor 1118 are three contacts: 1104, 1106, and 1108. The contact 1104 is adapted to receive a reference ground signal at a distal end and to transmit the reference ground signal toward a proximal end at the floor 1118 of the open chamber 1102. The ground reference signal then enters a reference circuit 1112, which is housed in a supply circuit 1110 inside a transmitter 202, as shown in FIG. 11C.

The contact 1106 is adapted to receive a power signal to recharge the battery 412 of the transmitter 202. The power signal is received at a distal end of the contact 1106 and enters the power circuit 1114 via a proximal end of the contact 1106. The power circuit 1114 is also housed in the supply circuit 1110. Both the reference circuit 1112 and the power circuit 1114 allow the battery 412 of the transmitter 202 to be recharged.

The remaining contact 1108 receives a programming signal at its distal end, and conducts the programming signal to a programming circuit 1116 in the transmitter 202. Thus, the interface 416 of the transmitter not only can receive power signals to recharge the battery 412 of the transmitter 202, but it also can receive programming signals to configure or calibrate the transmitter 202 without having to open up the transmitter 202.

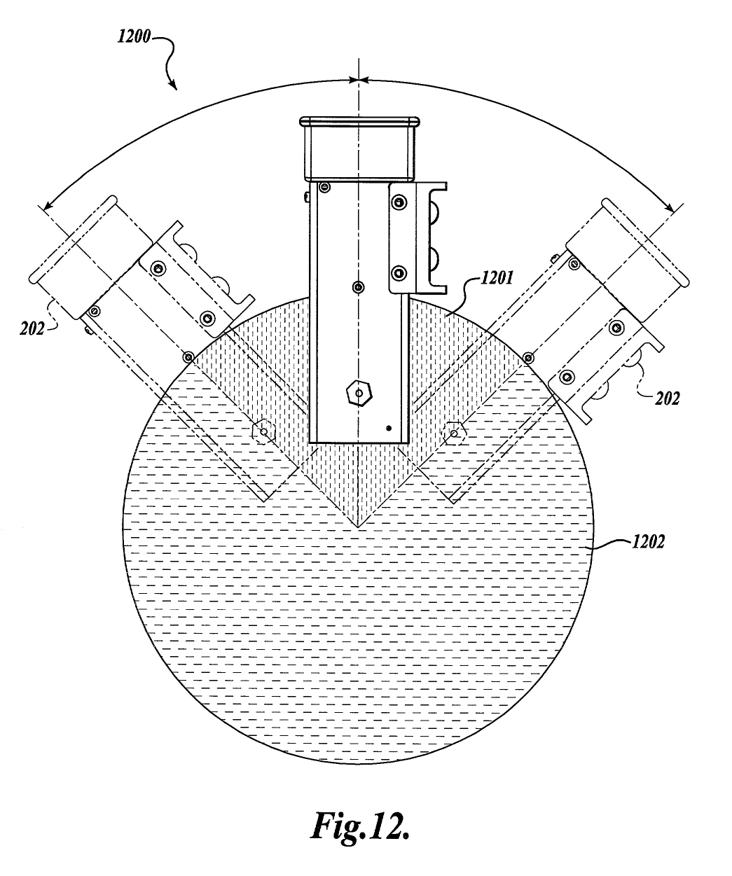

FIG. 12 illustrates a plan view of a side of the transmitter 202. Depending on of the orientation of the transmitter 202, the operation of the transmitter 202 will change. For example, if a logging worker orients the transmitter 202 at an angle within the range of about 0° to about +45°, the transmitter 202 is adapted to transmit encoded signals containing data. Similarly, encoded signals are transmitted if the transmistter 202 is oriented at an angle within the range of about 0° to about −45°. At an angle in the range greater than about −45° and greater than about +45°, the transmitter 202 is adapted to transmit voice information. The use of the transmitter's orientation to change its functionality enhances the user interface and increases the usability of the transmitter 202.

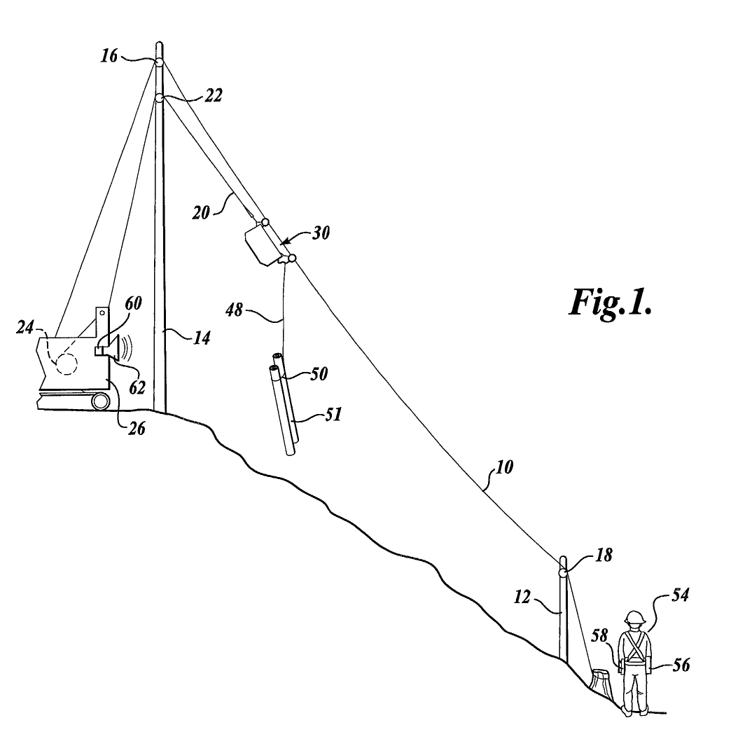

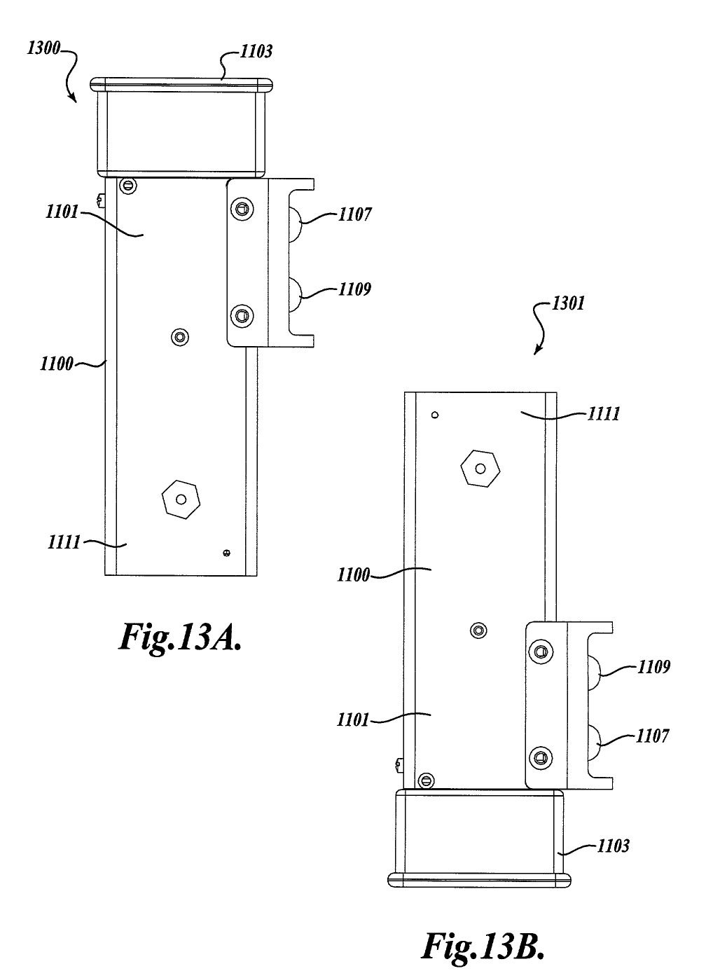

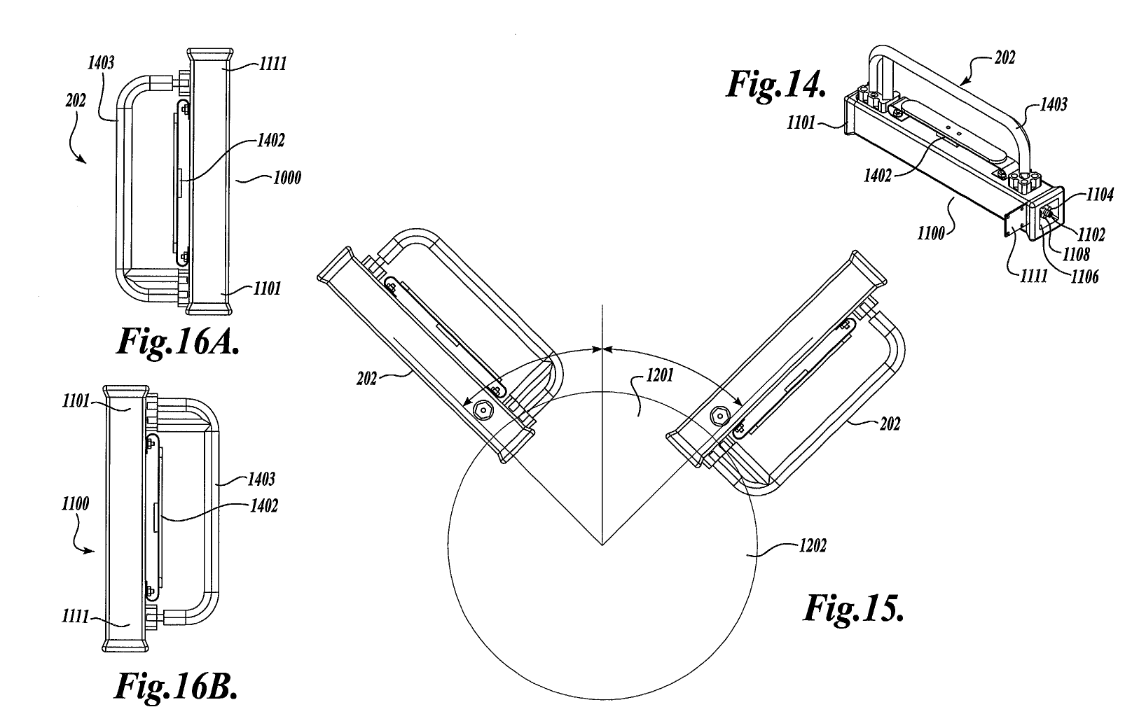

FIGS. 13A-B illustrate a plan view of a side of the transmitter 202 showing two orientations for storing the transmitter 202. Orientation 1300, as shown in FIG. 13A, allows the transmitter 202 to be stored by using the bottom 1111 as a surface to rest the transmitter 202 in a first storage position. FIG. 1-3B shows orientation 1301 where the transmitter 202 is stored by using the top 1101 with the first cover 1103 to rest the transmitter 202 in a second storage position.

Although the process steps described above and shown in FIGS. 6-8 are shown in a particular sequence, it would be apparent to those skilled in the art that such steps could be performed in a different order and still achieve the functionality described. Moreover, the method described in FIG. 6D, among other places, and circuit components described in FIG. 9A, among other places, are just one of many other suitable implementations for modulating the encoded signal onto the RF carrier signal. As discussed above, a single transmitter can be manufactured to both control the air horn as well as to control a piece of yarding machinery, such as a motorized carriage. This minimizes the number of equipment that logging workers have to carry. It may help to increase safety, reduce fatigue, increase ability to communicate, and help to improve mobility. Regarding the user interface, the immediate audio feedback now provided on the transmitter 202 may enhance its operations and safety of logging workers. While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A system for communicating encoded signals to control a device for performing work related to yarding operations, comprising:
a transmitter for transmitting an encoded signal having at least two digital portions, a first portion of the at least two digital portions being defined as a preamble, a second portion of the at least two digital portions being defined as an action code; and
a receiver for receiving the encoded signal to produce a controlling signal, the receiver being activated to process the action code to produce the controlling signal, thereby controlling the device for performing work related to yarding operations, when the preamble is of a predetermined pattern.

2. The system of claim 1, wherein the transmitter includes a first piece of static memory for storing a source node identifier and a destination node identifier, the transmitter transmitting the encoded signal having a third portion being defined as a network identifier, the network identifier containing the source node identifier and the destination node identifier, the receiver including a second piece of static memory for storing a predetermined destination node identifier and being programmed to recognize a set of source node identifiers, the receiver being activated to discard the encoded signal when either the source node identifier is not a member of the set of source node identifiers or the destination node identifier is different from the predetermined destination node identifier, thereby inhibiting unauthorized signals from controlling the device for performing work related to yarding operations.

3. The system of claim 2, wherein the transmitter includes a single-axis tilt detector for producing a first quantity that is indicative of the position of the transmitter along a horizontal plane and a second quantity that is indicative of the position of the transmitter along a vertical plane, the first quantity and the second quantity defining an orientation of the transmitter.

4. The system of claim 3, wherein the transmitter includes a counter for counting a span of time in which the orientation of the transmitter does not change within a predetermined period of time, thereby defining a duration that the transmitter has laid motionless.

5. The system of claim 4, wherein the transmitter includes a third piece of static memory for storing a device identifier, the device identifier being a serial number that is unique to the transmitter.

6. The system of claim 5, wherein the transmitter includes a battery having a level of energy, the battery for supplying power to operate the transmitter.

7. The system of claim 6, wherein the transmitter includes a lost processor for running a piece of software that transmits a lost encoded signal being composed of multiple digital portions that can be decoded by a transceiver to find the transmitter if the transmitter is lost during yarding operations.

8. The system of claim 7, wherein the lost encoded signal includes a first portion being defined as a lost preamble, the transceiver being adapted to discard the lost encoded signal when the lost preamble is different from a predetermined lost preamble.

9. The system of claim 8, wherein the lost encoded signal includes a second portion being defined as a lost network identifier, the lost network identifier having the source node identifier and the destination node identifier, the transceiver being activated to discard the lost encoded signal when either the source node identifier is not a member of the set of source node identifiers or the destination node identifier is different from the predetermined destination node identifier, thereby inhibiting undesired signals from confusing the receiver in finding the transmitter that is lost.

10. The system of claim 9, wherein the lost encoded signal includes a third portion that contains the device identifier, thereby allotting the transceiver to recognize the transmitter that is lost.

11. The system of claim 10, wherein the lost encoded signal includes a fourth portion containing the first quantity that is indicative of the position of the transmitter along the horizontal plane and a seventh portion containing the second quantity that is indicative of the position of the transmitter along a vertical plane, thereby allowing the transceiver to derive the orientation of the transmitter lying on the ground if the transmitter is lost.

12. The system of claim 11, wherein the lost encoded signal includes a fifth portion containing the duration that the transmitter has laid motionless.

13. The system of claim 12, wherein the lost encoded signal includes a sixth portion containing the level of the battery of the transmitter, the battery level being indicative of the remaining level of energy of the battery of the transmitter, thereby allowing the transceiver to calculate the remaining time the transmitter may operate.

14. The system of claim 13, wherein the lost circuit of the transmitter is adapted to receive commands from the transceiver so as to aid the transceiver finding the transmitter if the transmitter is lost during yarding operations.

15. The system of claim 1, wherein the transmitter includes an aural indicator that audibly provides information regarding a state of the transmitter so as to help confirm for a user that the transmitter has desirably responded to an action of the user or to help the user to locate the transmitter if the transmitter is lost.

16. The system of claim 1, wherein the transmitter includes a scrambler that scrambles a portion of the encoded signal to improve the distribution of bits in the encoded signal, thereby enhancing the ability of the receiver to receive the encoded signal.

17. The system of claim 2, wherein the receiver includes a recorder that records the encoded signal based upon the network identifier, thereby aiding in the determination of the sequence of yarding activities that lead to an accident relating to yarding operations.

18. The system of claim 3, wherein the transmitter includes a microphone for receiving voice communication and transmitting the voice communication to the receiver, the voice communication being modulated via frequency modulation and being framed with a digital squelch code so as to inhibit false reception prior to transmitting the voice communication to the receiver.

19. The system of claim 18, wherein the voice communication is transmitted and the transmission of the encoded signal is inhibited when the transmitter is in a first orientation, and wherein the encoded signal is transmitted and the transmission of the voice communication is inhibited when the transmitter is in a second orientation.

20. The system of claim 6, wherein the transmitter includes an interface for receiving external power to charge the battery, the interface being adapted to receive programming signals to program the transmitter when external power is not presented at the interface to charge the battery.

21. A method for communicating encoded signals transmitted by a transmitter and received by a receiver to control a device for performing work related to yarding operations, comprising:
sleeping to conserve energy stored in a battery until the transmitter is awakened by a switch activation for transmitting an encoded signal to the receiver that contains at least two digital portions, a first portion of the at least two digital portions being defined as a preamble, a second portion of the at least two digital portions being defined as an action code; and
processing the action code by the receiver upon receiving the at least two digital portions to produce a controlling signal, thereby controlling the device for performing work related to yarding operations, when the preamble is of a predetermined pattern.

22. The method of claim 21, wherein the act of transmitting includes transmitting a third portion being defined as a network identifier, the network identifier containing a source node identifier and a destination node identifier, the receiver being programmed to recognize a predetermined destination node identifier and a set of source node identifiers, the act of receiving including discarding the encoded signal when either the source node identifier is not a member of the set of source node identifiers or the destination node identifier is different from the predetermined destination node identifier, thereby inhibiting unauthorized signals from controlling the device for performing work related to yarding operations.

23. The method of claim 21, wherein sleeping to conserve energy stored in the battery until the transmitter is awakened by a scheduled task to check a state of a programming interface of the transmitter is defined as an active state, the transmitter changing from the active state to a program state when a programming signal is sensed by the transmitter on a programming pin of the transmitter, the transmitter being receptive to programming instructions when the transmitter is in the program state.

24. The method of claim 21, wherein sleeping to conserve energy stored in the battery until the transmitter is awakened by a scheduled task to check the level of the battery, the transmitter outputting an audible signal when the level of the battery has been reduced to a predetermined low threshold value.

25. The method of claim 21, wherein sleeping to conserve energy stored in the battery until the transmitter is awakened to perform a scheduled task is defined as an active state, the scheduled task including checking an orientation of the transmitter.

26. The method of claim 25, wherein the transmitter changes from the active state to a storage state when the act of checking the orientation of the transmitter determines that the transmitter is oriented vertically and that the transmitter is motionless, thereby indicating that the transmitter is fitted into a charging unit to charge the battery.

27. The method of claim 26, wherein the transmitter changes from the active state to a dropped state when the act of checking the orientation of the transmitter determines that the transmitter is not oriented vertically and that the transmitter is motionless, thereby indicating that the transmitter has been inadvertently dropped on the ground.

28. The method of claim 27, wherein the transmitter changes from the dropped state to an alert state after a duration of time has expired, the transmitter outputting an alert signal, the alert signal being selected from a group consisting of aural alert signals, radio frequency alert signals, and voice alert signals, the aural alert signals being adapted to be audible, the radio frequency alert signals being a package of multiple digital portions, and the voice alert signals being voice communication picked up by an enabled microphone of the transmitter for transmission to a transceiver, thereby aiding to locate the transmitter when the transmitter is lost.

29. The method of claim 25, wherein the transmitter transmits voice communication to the receiver when a switch is actuated on the transmitter, the transmitter is oriented vertically, and the transmitter is in the active state.

30. The method of claim 29, wherein the transmitter ceases the transmission of voice communication to the receiver after a period of time, voice communication being reestablished by the transmitter when the switch is actuated again on the transmitter, the transmitter is oriented vertically, and the transmitter is still in the active state.

31. A transmitter for transmitting encoded signals to a receiver to control an aural signaling device for forewarning of impending changes in operations of yarding machinery, the transmitter comprising:
a first component for responding to a switch actuation to output an encoded signal having at least three digital portions, a first portion being defined as a preamble, a second portion being defined as a network identifier, and a third portion being defined as an action code, the network identifier being processed by the receiver when the preamble is of a predetermined pattern, the action code being processed by the receiver to control the aural signaling device when the network identifier is recognized by the receiver, thereby inhibiting signals with unrecognized network identifiers from controlling the aural signaling device;
a frequency synthesizer for producing the encoded signal at a radio frequency for transmission by varying the frequency of the encoded signal; and
an antenna for radiating the encoded signal so that the receiver may receive the encoded signal to control the aural signaling device.

32. The transmitter of claim 31, wherein the frequency synthesizer includes a reference crystal oscillator for generating a reference frequency, the crystal oscillator being receptive to the data signal for modulating the reference frequency so as to produce a modulated encoded signal.

33. The transmitter of claim 32, wherein the frequency synthesizer includes a voltage-controlled oscillator for oscillating the encoded signal to produce an oscillated encoded signal for the antenna to radiate, the voltage-controlled oscillator being receptive to a filtered voltage signal for adjusting the frequency by which the voltage-controlled oscillator oscillates the encoded signal.

34. The transmitter of claim 33, wherein the frequency synthesizer includes a second component for multiplying the reference frequency with the oscillated encoded signal so as to produce the voltage signal having a magnitude and sign that are proportional to the phase difference between the reference frequency and the oscillated encoded signal, the second component being receptive to a phase-locked loop programming signal to change the frequency of the oscillated encoded signal by a sub-multiple of the reference frequency, thereby shifting from one channel to another channel for communication.

35. The transmitter of claim 34, wherein the frequency synthesizer includes a loop filter to low-pass filter the voltage signal to produce the filtered voltage signal being used by the voltage-controlled oscillator to adjust the frequency by which the voltage-controlled oscillator oscillates the encoded signal.

36. The transmitter of claim 35, further comprising a radio-frequency power amplifier for amplifying the oscillated encoded signal coming from the frequency synthesizer to produce an amplified encoded signal when a transmitter power control signal turns on the radio-frequency power amplifier, thereby inhibiting undesired transmissions.

37. The transmitter of claim 36, further comprising a harmonic cleansing filter for low-pass filtering the amplified encoded signal to produce a cleansed encoded signal, thereby attenuating the harmonics associated with the amplified encoded signal.

38. The transmitter of claim 37, wherein the frequency synthesizer is receptive to a transmitter standby control signal, the frequency synthesizer being deactivated when the transmitter standby control signal is at a first predetermined level and being activated when the transmitter standby control signal is at a second predetermined level, thereby conserving the energy of a battery of the transmitter.

39. The transmitter of claim 36, further comprising a finder receiver for receiving a finder signal from the antenna at a predetermined frequency so that the transmitter may respond to the finder signal and perform a task to aid in it being found when the transmitter is lost.

40. The transmitter of claim 39, further comprising a high-pass filter coupled between the antenna and the receiver, the high-pass filter being adapted to pass the finder signal to the finder receiver while inhibiting the cleansed encoded signal from entering the finder receiver.

41. A transmitter for transmitting encoded signals to a receiver to control a motorized carriage for transporting logs from a remote location to a yarder, the transmitter comprising:
a first component for responding to a combination of switch actuations to output an encoded signal having at least three digital portions, a first portion being defined as a preamble, a second portion being defined as a network identifier, and a third portion being defined as an action code, the network identifier being processed by the receiver when the preamble is of a predetermined pattern, and the action code being processed by the receiver to control the motorized carriage when the network identifier is recognized by the receiver, thereby inhibiting signals with unrecognized network identifiers from controlling the motorized carriage;
a frequency synthesizer for modulating the encoded signal onto a radio frequency carrier for transmission; and
an antenna for radiating the encoded signal so that the receiver may receive the encoded signal to control the motorized carriage.

42. The transmitter of claim 41, further comprising a finder receiver for receiving a finder signal from the antenna at a predetermined frequency so that the transmitter may respond to the finder signal and perform a task to aid in it being found when the transmitter is lost.

43. The transmitter of claim 42, further comprising a high-pass filter coupled between the antenna and the receiver, the high-pass filter being adapted to pass the finder signal to the finder receiver while inhibiting the cleansed encoded signal from entering the finder receiver.

44. A receiver for receiving encoded signals from a transmitter to control an aural signaling device for forewarning of impending changes in operations of yarding machinery, the receiver comprising:
a radio-frequency circuit for receiving at least one of two signals, one of the two signals being a modulated voice signal and the other being a modulated encoded signal that is composed of at least three digital portions, a first portion being defined as a preamble, a second portion being defined as a network identifier, and a third portion being defined as an action code;
a controller circuit for processing the network identifier when the preamble is of a predetermined pattern and for processing the action code to control the aural signaling device when the network identifier is a member of a set of network identifiers that are recognized by the controller circuit, thereby inhibiting signals with unrecognized network identifiers from controlling the aural signaling device; and
a relay circuit for processing the action code to control other pieces of yarding machinery equipment.

45. The receiver of claim 44, wherein the radio-frequency circuit includes a front end stage for receiving the at least one of two signals, the front end stage including:
a first radio frequency filter for bandpass filtering the at least one of two signals to produce a first filtered signal;
a radio frequency amplifier for amplifying the first filtered signal to produce a first amplified signal; and a second radio frequency filter for band pass filtering the first amplified encoded signal to produce a second filtered signal.

46. The receiver of claim 45, wherein the radio-frequency circuit includes a splitter to split the second filtered signal to produce a split signal being sent into two paths, the two paths being a voice path and a data path.

47. The receiver of claim 46, wherein the radio-frequency circuit includes two down converters to shift the frequency of the split signal to produce a down-converted signal so as to decrease transmission line losses, one of the down converters being adapted to produce the down-converted signal in the voice path and the other of the down converters being adapted to produce the down-converted signal in the data path.

48. The receiver of claim 47, wherein the radio-frequency circuit includes two intermediate frequency strip stages to cleanse the down-converted signal and produce a strip signal, one of the intermediate frequency strip stages being adapted to produce the strip signal in the voice path and the other of the intermediate frequency strip stages being adapted to produce the strip signal in the data path, each intermediate frequency strip stage including:
a four-pole filter for bandpass filtering the down-converted signal to produce a third filtered signal; and
an intermediate frequency amplifier for amplifying the third filtered signal to produce a second amplified signal.

49. The receiver of claim 48, wherein the radio-frequency circuit includes two receiving stages for demodulating the second amplified signal, each receiving stages including a six-pole filter to bandpass filter the second amplified signal prior to demodulation, one of the receiving stages being adapted to produce a demodulated voice signal in the voice path and the other receiving stage being adapted to produce a demodulated encoded signal in the data path.

50. The receiver of claim 49, wherein the demodulated voice signal includes two components, wherein the radio-frequency circuit includes a lowpass filter for filtering one of the two components of the demodulated voice signal to produce a fourth filtered signal, the fourth filtered signal being applied to a Schmitt trigger to produce a digital squelch code signal.

51. The receiver of claim 50, wherein the radio-frequency circuit includes a deemphasis filter for filtering the other of the two components of the demodulated voice signal to produce a fifth filtered signal, the fifth filtered signal being applied to a lowpass filter to produce voice communication originated at the transmitter.

52. The receiver of claim 49, wherein the radio-frequency circuit includes a Gaussian Minimum Shift Keying demodulator for receiving the demodulated data signal to produce the encoded signal.

53. A receiver for receiving encoded signals from a transmitter to control a motorized carriage for transporting logs from a remote location to a yarder, the receiver comprising:
a radio-frequency circuit for receiving at least one of two signals, one of the two signals being a modulated voice signal and the other being a modulated encoded signal that is composed of at least three digital portions, a first portion being defined as a preamble, a second portion being defined as a network identifier, and a third portion being defined as an action code; and
a controller circuit for processing the network identifier when the preamble is of a predetermined pattern and for processing the action code to control the motorized carriage when the network identifier is a member of a set of network identifiers that are recognized by the controller circuit, thereby inhibiting signals with unrecognized network identifiers from controlling the motorized carriage.

54. The receiver of claim 53, wherein the radio-frequency circuit includes a front end stage for receiving the at least one of two signals, the front end stage including:
a first radio frequency filter for bandpass filtering the at least one of two signals to produce a first filtered signal;
a radio frequency amplifier for amplifying the first filtered signal to produce a first amplified signal; and
a second radio frequency filter for band pass filtering the first amplified encoded signal to produce a second filtered signal.

55. The receiver of claim 54, wherein the radio-frequency circuit includes a splitter to split the second filtered signal to produce a split signal being sent into two paths, the two paths being a voice path and a data path.

56. The receiver of claim 55, wherein the radio-frequency circuit includes two down converters to shift the frequency of the split signal to produce a down-converted signal so as to progressively amplify and isolate the modulated signal, one of the down converters being adapted to produce the down-converted signal in the voice path and the other of the down converters being adapted to produce the down-converted signal in the data path.

57. The receiver of claim 56, wherein the radio-frequency circuit includes two intermediate frequency strip stages to cleanse the down-converted signal and produce an intermediate signal, one of the intermediate frequency strip stages being adapted to produce the intermediate signal in the voice path and the other of the intermediate frequency strip stages being adapted to produce the intermediate signal in the data path, each intermediate frequency strip stage including
a four-pole filter for bandpass filtering the down-converted signal to produce a third filtered signal; and
an intermediate frequency amplifier for amplifying the third filtered signal to produce a second amplified signal.

58. The receiver of claim 57, wherein the radio-frequency circuit includes two receiving stages for demodulating the second amplified signal, each receiving stages including a six-pole filter to bandpass filter the second amplified signal prior to demodulation, one of the receiving stages being adapted to produce a demodulated voice signal in the voice path and the other receiving stage being adapted to produce a demodulated encoded signal in the data path.

59. The receiver of claim 58, wherein the demodulated voice signal includes two components, wherein the radio-frequency circuit includes a lowpass filter for filtering one of the two components of the demodulated voice signal to produce a fourth filtered signal, the fourth filtered signal being applied to a Schmitt trigger to produce a digital squelch code signal.

60. The receiver of claim 59, wherein the radio-frequency circuit includes a deemphasis filter for filtering the other of the two components of the demodulated voice signal to produce a fifth filtered signal, the fifth filtered signal being applied to a lowpass filter to produce voice communication originated at the transmitter.

61. The receiver of claim 58, wherein the radio-frequency circuit includes a Gaussian Minimum Shift Keying demodulator for receiving the demodulated data signal to produce the encoded signal.

62. An interface for recharging a battery of a transmitter and for programming the transmitter used to control a device for performing work related to yarding operations, the interface comprising:
an open chamber being recessed into the transmitter;
a first contact located within the open chamber and having a proximal end and a distal end, the proximal end of the first contact being coupled to a circuit for providing a ground reference to the transmitter, the distal end of the first contact being adapted to receive an external ground reference;
a second contact located within the open chamber and having a proximal end and a distal end, the proximal end of the second contact being coupled to a circuit for recharging a battery of the transmitter, the distal end of the first contact being adapted to receive an external power signal; and
a third contact located within the open chamber and having a proximal end and a distal end, the proximal end of the third contact being coupled to a programming circuit for reprogramming the transmitter, the distal end of the third contact being adapted to receive an external programming signal.

63. A signal for carrying information to control a device for performing work related to yarding operations, the signal being transmitted by a transmitter and being received by a receiver, the signal comprising:
a first digital portion being defined as a preamble that contains a bit pattern;
a second digital portion being defined as a network identifier that has a source identifier and a destination identifier, the network identifier being processible by the receiver if the bit pattern of the preamble is as expected by the receiver; and
a third digital portion being defined as an action code, the action code being processible by the receiver if the destination identifier is as expected by the receiver and the source identifier is a member of a set of source identifiers recognized by the receiver.

64. A method for communicating lost encoded signals transmitted by a transmitter and received by a transceiver to find the transmitter that transmits information related to yarding operations, comprising:
transmitting by the transmitter a lost encoded signal that contains at least three digital portions, a first portion of the at least two digital portions being defined as a preamble, a second portion being defined as a network identifier, and a third portion being defined as a device identifier; and
processing the network identifier by the transceiver upon receiving the at least three digital portions to locate the lost transmitter when the preamble is of a predetermined pattern, and processing the device identifier to identify the lost transmitter when the transceiver recognizes the network identifier.

65. The method of claim 64, wherein processing includes processing the network identifier having a source node identifier and a transceiver node identifier, the transceiver being programmed to recognize a predetermined transceiver node identifier and a set of source node identifiers, the act of receiving including discarding the encoded signal when either the source node identifier is not a member of the set of source node identifiers or the transceiver node identifier is different from the predetermined transceiver node identifier, thereby inhibiting unauthorized signals from interfering with the process for finding the lost transmitter.

66. The method of claim 65, wherein the lost encoded signal includes a fourth portion that contains a sync, thereby allowing the transceiver to recognize a transition from the preamble to the rest of the lost encoded signal.

67. The method of claim 66, wherein the lost encoded signal includes a fifth portion containing the first quantity that is indicative of the position of the transmitter along the horizontal plane and a sixth portion containing the second quantity that is indicative of the position of the transmitter along a vertical plane, thereby allowing the transceiver to derive the orientation of the transmitter.

68. The method of claim 67, wherein the lost encoded signal includes a seventh portion containing a duration of time that the transmitter has laid motionless.

69. The method of claim 68, wherein the lost encoded signal includes an eighth portion containing a level of a battery of the transmitter, the battery level being indicative of the remaining level of energy of the battery of the transmitter, thereby allowing the transceiver to calculate the remaining time the transmitter may operate.

70. A signal for carrying information to find a transmitter that transmits information related to yarding operations, the signal being transmitted by the transmitter and being received by a transceiver, the signal comprising:
a first digital portion being defined as a preamble that contains a first bit pattern;
a second digital portion being defined as a sync that contains a second bit pattern;
a third digital portion being defined as a network identifier that has a source identifier and a transceiver identifier, the network identifier being processible by the transceiver if the first bit pattern of the preamble and the second bit pattern of the sync are as expected by the transceiver.

71. The signal of claim 70, further comprising a fourth digital portion being defined as a device identifier, the device identifier being processible by the transceiver if the transceiver identifier is as expected by the transceiver and the source identifier is a member of a set of source identifiers recognized by the transceiver.

72. The signal of claim 71, further comprising a fifth digital portion being defined as a level of a battery of the transmitter, the battery level being indicative of the remaining level of energy of the battery of the transmitter, thereby allowing the transceiver to calculate the remaining time the transmitter may operate.

73. The signal of claim 72, further comprising a sixth digital portion containing the first quantity that is indicative of the position of the transmitter along the horizontal plane.

74. The signal of claim 73, further comprising a seventh portion containing the second quantity that is indicative of the position of the transmitter along a vertical plane, both the first quantity and the second quantity allowing the transceiver to derive the orientation of the transmitter.

75. The signal of claim 74, further comprising an eighth portion containing a duration of time that the transmitter has laid motionless.
